(19) United States
(12) Patent Application Publication
(10) Pub. No.: US 2024/0067822 A1
(43) Pub. Date: Feb. 29, 2024

(54) RESIN COMPOSITION, NONWOVEN FABRIC AND TEXTILE PRODUCT OBTAINED USING SAME, SEPARATOR FOR POWER STORAGE ELEMENT, SECONDARY BATTERY, AND ELECTRIC DOUBLE-LAYER CAPACITOR

(71) Applicant: Toray Industries, Inc., Tokyo (JP)

(72) Inventors: Shuhei Tanabe, Otsu-shi, Shiga (JP); Tomoyuki Yuba, Otsu-shi, Shiga (JP); Natsuko Tobata, Tokyo (JP)

(73) Assignee: Toray Industries, Inc., Tokyo (JP)

(21) Appl. No.: 18/033,207

(22) PCT Filed: Oct. 27, 2021
(86) PCT No.: PCT/JP2021/039636

§ 371 Date: Jun. 30, 2023

(30) Foreign Application Priority Data
Nov. 4, 2020 (JP) 2020-184216

(51) Int. Cl. C08L 81/06; C08G 73/10; C08G 73/14; C08G 73/18; C08G 73/22; C08G 75/23; C08L 75/02; C08L 79/04; C08L 79/08; D04H 1/4326; D04H 1/4334; D04H 1/56; D04H 1/728; H01G 11/52; H01M 50/414; H01M 50/423; H01M 50/44

(52) U.S. Cl. CPC C08L 81/06; C08G 73/10; C08G 73/14; C08G 73/18; C08G 73/22; C08G 75/23; C08L 75/02; C08L 79/04; C08L 79/08; D04H 1/4326; D04H 1/4334; D04H 1/56; D04H 1/728; H01G 11/52; H01M 50/414; H01M 50/423; H01M 50/44; C08L 2203/12; D10B 2331/06; D10B 2331/12; D10B 2331/14; D10B 2401/04; D10B 2401/063; D10B 2505/00

(57) ABSTRACT

A problem to be solved by the present invention is to provide a resin composition suitable for spinning, particularly electrospinning, and in addition, to provide a heat-resistant non-woven fabric having excellent strength and a method of producing the same. A main object of the present invention is: to provide a resin composition including: (a) at least one heat-resistant resin or a precursor thereof, the heat-resistant resin being selected from the group consisting of a heat-resistant resin containing a nitrogen atom and a heat-resistant resin containing, in the main chain, a group selected from the group consisting of ether group, ketone group, sulfone group, and sulfide group; (b) a solvent; and (c) a surfactant having a fluoroalkyl group; and to form a non-woven fabric using the resin composition by an electrospinning method.

### CROSS REFERENCE TO RELATED APPLICATIONS

This application is the U.S. National Phase application of PCT/JP2021/039636 filed Oct. 27, 2021, which claims priority to Japanese Patent Application No. 2020-184216, filed Nov. 4, 2020, the disclosures of these applications being incorporated herein by reference in their entireties for all purposes.

### FIELD OF THE INVENTION

The present invention relates to: a resin composition for forming a non-woven fabric by an electrospinning method; a non-woven fabric and a fiber product made using the same; a separator for an electricity storage element; a secondary battery; and an electric double layer capacitor.

### BACKGROUND OF THE INVENTION

In recent years, an electronic device has been desired to have a low dielectric constant, and accordingly, a porous heat resistant material has been desired. As a base material for such a material, a heat-resistant non-woven fabric that endures a soldering process is one of the promising candidates. In addition, a heat-resistant non-woven fabric can undergo metal plating to be thereby made usable for applications such as: a light and excellent electromagnetic wave shielding material; a heat resistant bag filter for removing dust from combustion gas emitted from a factory or the like; a gas separation membrane or a water separation membrane; and a separator for a lithium ion battery or an electric double layer capacitor. In these applications, a metal-plated heat-resistant non-woven fabric is attracting attention as a material having excellent ion permeability and also high mechanical strength and heat resistance.

In addition, in aircraft applications, a demand for a more porous thermal insulation sound absorbing material having high reliability in a high temperature environment and a low temperature environment is increasing.

As an approach to obtaining such a non-woven fabric as above-described, Patent Literature 1 discloses: a polyimide composition having a specific structure suitable for an electrospinning method; and a method of producing a non-woven fabric using the composition. The non-woven fabric is used for a bag filter to be used at high temperature and a filter for exhaust gas from combustion.

Patent Literature 2 discloses: a polyimide fiber obtained by discharging a polyimide solution through a nozzle, and subjecting the solution to a high-speed air flow that intersects the solution; and the use of the fiber for a heat resistant bag filter, a thermal insulation sound absorbing material, heat resistant clothes, and the like.

Patent Literature 3 discloses a separator for a lithium ion secondary battery, the separator produced using a resin solution obtained by allowing a polyamic acid to react with an epoxy group-containing partial condensate of an alkoxysilane. Modifying a polyamic acid with silane increases the adhesion of plating. In addition, in spinning, a solution discharged from a spinning nozzle is subjected to an air flow heated to 50 to 350° C., thus allowing fibers to be collected while an imidization reaction and a sol-gel reaction are advanced.

Patent Literature 4 discloses: a polyamide, a polyimide, and a polyamide imide resin, wherein an alkyl group or a fluoroalkyl group is bound to an end of the polymer; and a non-woven fabric or separator produced using a solution of the resin.

### PATENT LITERATURE

Patent Literature 1: JP2011-132611A

Patent Literature 2: WO2009/054349

Patent Literature 3: JP2012-251287A

Patent Literature 4: WO2019/009037

### SUMMARY OF THE INVENTION

However, the compositions disclosed in these articles of Patent Literature have a problem of poor stability during spinning. For example, a bumpy defect called bead, at which the fiber diameter abruptly becomes larger, is generated in the fiber, or the electrostatic repulsion during spinning becomes unstable, causing the fiber to lose shape, and result in round droplets deposited on a substrate. Such a problem leads to a decrease in the strength of a non-woven fabric, posing an issue.

One of the objects of the present invention is to provide a resin composition suitable for spinning, particularly electrospinning. Another of the objects is to provide a heat-resistant non-woven fabric having excellent strength and a method of producing such a heat-resistant non-woven fabric.

The present invention is a resin composition for forming a non-woven fabric by an electrospinning method, including: (a) at least one heat-resistant resin or a precursor thereof, the heat-resistant resin being selected from the group consisting of a heat-resistant resin containing a nitrogen atom and a heat-resistant resin containing, in the main chain, a group selected from the group consisting of ether group, ketone group, sulfone group, and sulfide group; (b) a solvent; and (c) a surfactant having a fluoroalkyl group.

In addition, the present invention is a non-woven fabric including: (a) at least one heat-resistant resin or a precursor thereof, the heat-resistant resin being selected from the group consisting of a heat-resistant resin containing a nitrogen atom and a heat-resistant resin containing, in the main chain, a group selected from the group consisting of ether group, ketone group, sulfone group, and sulfide group; and (c) a surfactant having a fluoroalkyl group.

The present invention makes it possible to inhibit the generation of a bead during spinning, and to obtain a fiber having a stable diameter. In particular, in electrospinning, the resin solution is not inhibited from division due to electrostatic repulsion during spinning, making it possible to obtain a non-woven fabric having no deposited droplet. In addition, the present invention makes it possible to obtain a heat-resistant non-woven fabric having excellent strength.

### DETAILED DESCRIPTION OF EMBODIMENTS OF THE INVENTION

Below, suitable embodiments of a resin composition, a non-woven fabric, a method of producing a non-woven fabric, a fiber product, a separator, a secondary battery, and an electric double layer capacitor according to the present invention will be described in detail. In this regard, the present invention should not be limited to these embodiments.

### Resin Composition

In a resin composition according to an embodiment of the present invention, one or more of the following is/are used as (a) a resin component;
i) a heat-resistant resin containing a nitrogen atom;
ii) a heat-resistant resin having, in the main chain, a group selected from the group consisting of ether group, ketone group, sulfone group, and sulfide group;
iii) a precursor of the heat-resistant resin in i) above; and
iv) a precursor of the heat-resistant resin in ii) above.

In addition, a resin composition according to the present invention further includes at least (b) a solvent and (c) a surfactant having a fluoroalkyl group in addition to (a) the resin component.

Here, a “heat-resistant resin” as used in the present invention refers to a resin having a 5% weight loss temperature of 200° C. or more. In addition, a “precursor of a heat-resistant resin” refers to a substance that affords a heat-resistant resin through a thermal or chemical treatment, such as cross-linking, thermal ring closure, or chemical ring closure, without undergoing any addition reaction.

In addition, a 5% weight loss temperature is a temperature determined as follows: a resin is heated to 150° C. under a nitrogen gas stream at a heating rate of 10° C./minute to remove adsorbed water; then, the resin is once cooled to room temperature, and the weight W1 of the resin is measured; this resin is again heated at a heating rate of 10° C./minute; and a temperature at which the weight W2 of the resin during this heating satisfies W2/W1=0.95 is a 5% weight loss temperature.

### (a-1) Heat-Resistant Resin Containing Nitrogen Atom

The heat-resistant resin containing a nitrogen atom refers to a resin having, in a repeating structure of the polymer, a nitrogen atom-containing group, such as an amide group or a urea group, or a nitrogen atom-containing heterocycle, such as an imide ring or an oxazole ring, wherein the resin has a 5% weight loss temperature of 200° C. or more.

Examples of the heat-resistant resin containing a nitrogen atom include a polyimide, polyamide, polyurea, polyamide imide, polyazole (polybenzimidazole, polybenzoxazole, or polybenzothiazole), and the like.

It is more preferable that the heat-resistant resin containing a nitrogen atom is more preferably a resin having a structure represented by at least one selected from the following general formulae (1) to (5).

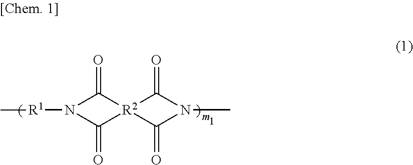

In the general formula (1), R¹ represents a C₂₋₅₀ divalent group. R² represents a C₄₋₅₀ tetravalent group. m₁ represents an integer of 1 to 10,000.

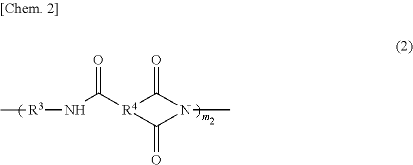

In the general formula (2), R³ represents a C₂₋₅₀ divalent group. R⁴ represents a C₄₋₅₀ trivalent group. m₂ represents an integer of 1 to 10,000.

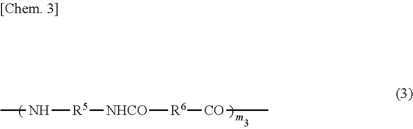

In the general formula (3), R⁵ represents a C₂₋₅₀ divalent group. R⁶ represents a C₂₋₅₀ divalent group. m₃ represents an integer of 1 to 10,000.

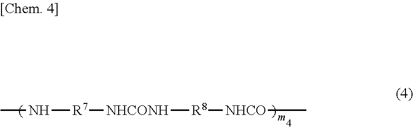

In the general formula (4), R⁷ represents a C₂₋₅₀ divalent group. R⁸ represents a C₂₋₅₀ divalent group. m₄ represents an integer of 1 to 10,000.

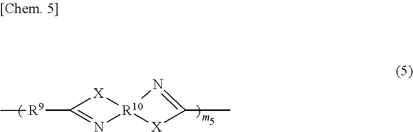

In the general formula (5), R⁹ represents a C₂₋₅₀ divalent group. R¹⁰ represents a C₄₋₅₀ tetravalent group. X represents a divalent group selected from —O—, —S—, —NH—, and —C(═O)O—.

m₅ represents an integer of 1 to 10,000.

In this regard, R¹ to R¹⁰ are each typically a residue of an aliphatic hydrocarbon, aromatic hydrocarbon, or nitrogen-containing aromatic hydrocarbon, and in addition, encompass: these residues bound via a linking group, such as a single bond, ether bond, thioether bond, ester bond, ketone bond, or sulfone bond; and the same residue except that part of the hydrogens thereof is/are each replaced with a monovalent functional group, such as an alkyl group, halogenated alkyl group, oxyalkyl group, oxyaryl group, nitro group, cyano group, or halogen.

A structure represented by the general formula (1) is a structural unit of a polyimide. In the general formula (1), R¹ represents a diamine residue. Examples of an amine component that gives a diamine residue include, but are not limited to: carboxyl group-containing diamines, such as 3,5-diaminobenzoic acid and 3-carboxy-4,4′-diaminodiphenyl ether; sulfonic acid-containing diamines, such as 3-sulfonic acid-4,4′-diaminodiphenyl ether; hydroxyl group-containing diamines, such as bis(3-amino-4-hydroxyphenyl)hexafluoropropane, bis(3-amino-4-hydroxyphenyl)sulfone, bis(3-amino-4-hydroxyphenyl)propane, bis(3-amino-4-hydroxyphenyl)methane, bis(3-amino-4-hydroxyphenyl) ether, bis(3-amino-4-hydroxy)biphenyl, bis(3-amino-4-hydroxyphenyl)fluorene, bis(4-amino-3-hydroxyphenyl)hexafluoropropane, bis(4-amino-3-hydroxyphenyl)sulfone, bis(4-amino-3-hydroxyphenyl)propane, bis(4-amino-3-hydroxyphenyl)methane, bis(4-amino-3-hydroxyphenyl) ether, bis(4-amino-3-hydroxy)biphenyl, and bis(4-amino-3-hydroxyphenyl)fluorene, or these same amines except that a hydroxyl group thereof is replaced with a thiol group, amino group, or carboxyl group; 3,4′-diaminodiphenyl ether, 4,4′-diaminodiphenyl ether, 3,4′-diaminodiphenyl methane, 4,4′-diaminodiphenyl methane, 3,4′-diaminodiphenyl sulfone, 4,4′-diaminodiphenyl sulfone, 3,4′-diaminodiphenyl sulfide, 4,4′-diaminodiphenyl sulfide, 1,4-bis(4-aminophenoxy)benzene, m-phenylene diamine, p-phenylene diamine, 2,4-diaminotoluene, 2,6-diaminotoluene, 1,5-naphthalene diamine, 2,6-naphthalene diamine, bis(4-aminophenoxyphenyl)sulfone, bis(3-aminophenoxyphenyl)sulfone, bis(4-aminophenoxy)biphenyl, bis{4-(4-aminophenoxy)phenyl} ether, 1,4-bis(4-aminophenoxy)benzene, 2,2′-dimethyl-4,4′-diaminobiphenyl, 2,2′-diethyl-4,4′-diaminobiphenyl, 3,3′-dimethyl-4,4′-diaminobiphenyl, 3,3′-diethyl-4,4′-diaminobiphenyl, 2,2′,3,3′-tetramethyl-4,4′-diaminobiphenyl, 3,3′,4,4′-tetramethyl-4,4′-diaminobiphenyl, and 2,2′-di(trifluoromethyl)-4,4′-diaminobiphenyl, or these same compounds except that part of the hydrogen atoms of an aromatic ring of the compound is/are replaced with an alkyl group or a halogen atom; aliphatic diamines, such as a cyclohexyl diamine or a methylenebiscyclohexylamine; and the like. These amines can be used singly or in combination of two or more kinds thereof.

In the general formula (1), R² represents a tetracarboxylic residue. Examples of an acid component that gives a tetracarboxylic residue include, but are not limited to: aromatic tetracarboxylic acids, such as pyromellitic acid, 3,3′,4,4′-biphenyltetracarboxylic acid, 2,3,3′,4′-biphenyltetracarboxylic acid, 2,2′,3,3′-biphenyltetracarboxylic acid, 3,3′,4,4′-benzophenonetetracarboxylic acid, 2,2′,3,3′-benzophenonetetracarboxylic acid, 2,2-bis(3,4-dicarboxyphenyl)hexafluoropropane, 2,2-bis(2,3-dicarboxyphenyl)hexafluoropropane, 1,1-bis(3,4-dicarboxyphenyl)ethane, 1,1-bis(2,3-dicarboxyphenyl)ethane, bis(3,4-dicarboxyphenyl)methane, bis(2,3-dicarboxyphenyl)methane, bis(3,4-dicarboxyphenyl)sulfone, bis(3,4-dicarboxyphenyl)ether, 1,2,5,6-naphthalenetetracarboxylic acid, 2,3,6,7-naphthalenetetracarboxylic acid, 2,3,5,6-pyridinetetracarboxylic acid, and 3,4,9,10-perylenetetracarboxylic acid; aliphatic tetracarboxylic acids, such as cyclobutane tetracarboxylic acid, 1,2,3,4-cyclopentane tetracarboxylic acid, cyclohexane tetracarboxylic acid, bicyclo[2.2.1.]heptane tetracarboxylic acid, bicyclo[3.3.1.]tetracarboxylic acid, bicyclo[3.1.1.]hepto-2-ene tetracarboxylic acid, bicyclo[2.2.2.]octane tetracarboxylic acid, and adamantane tetracarboxylic acid; and the like. These acids can be used singly or in combination of two or more kinds thereof.

A structure represented by the general formula (2) is a structural unit of a polyamide imide. A structure represented by the general formula (3) is a structural unit of a polyamide. A structure represented by the general formula (4) is a structural unit of a polyurea. A structure represented by the general formula (5) is a structural unit of a polyazole.

In the general formula (2) and the general formula (4), R³ and R⁷ each represent a diamine residue. Examples of an amine component that gives a diamine residue include the same components as in the above description of R¹ in the general formula (1).

In the general formula (2), R⁴ represents a tricarboxylic residue. Examples of an acid component that gives a tricarboxylic residue include, but are not limited to, a trimellitic acid, trimesic acid, diphenyl ether tricarboxylic acid, biphenyl tricarboxylic acid, and the like. These acids can be used singly or in combination of two or more kinds thereof.

In the general formula (4), R⁸ represents a diisocyanate residue, and represents a C₂₋₅₀ divalent group. Examples of a diisocyanate component that gives a diisocyanate residue include the same structure as in the above description of R¹ in the general formula (1) except that an amino group of the diamine is replaced with an isocyanate group. These diisocyanates can be used singly or in combination of two or more kinds thereof.

In the general formula (5), R¹⁰ represents a diamine residue wherein a group represented by X—H is bound at an ortho position with respect to an amino group. X represents a unit selected from —O—, —S—, —NH—, and —C(═O)O—. Such binding at an ortho position enables a polyazole to be obtained by dehydration ring closure. Examples of a diamine component that gives a diamine residue represented by the structure, —R²⁰(XH)₂—, include, but are not limited to: hydroxyl group-containing diamines, such as bis(3-amino-4-hydroxyphenyl)hexafluoropropane, bis(3-amino-4-hydroxyphenyl)sulfone, bis(3-amino-4-hydroxyphenyl)propane, bis(3-amino-4-hydroxyphenyl)methylene, bis(3-amino-4-hydroxyphenyl)ether, bis(3-amino-4-hydroxy)biphenyl, bis(3-amino-4-hydroxyphenyl)fluorene, bis(4-amino-3-hydroxyphenyl)hexafluoropropane, bis(4-amino-3-hydroxyphenyl)sulfone, bis(4-amino-3-hydroxyphenyl)propane, bis(4-amino-3-hydroxyphenyl)methylene, bis(4-amino-3-hydroxyphenyl)ether, bis(4-amino-3-hydroxy)biphenyl, and bis(4-amino-3-hydroxyphenyl)fluorene, or the same amines except that a hydroxyl group thereof is replaced with a thiol group, amino group, or carboxyl group; and the like. These amines can be used singly or in combination of two or more kinds thereof.

In the general formula (3), R⁵ represents a diamine residue. Examples of an amine component that gives a diamine residue include the same components as in the above description of R¹ in the general formula (1), but do not include a diamine residue wherein, as with R¹⁰, a group represented by X—H is bound at an ortho position with respect to an amino group.

In the general formula (3) and the general formula (5), R⁶ and R⁹ each represent a dicarboxylic residue. Examples of an acid component that gives a dicarboxylic residue include, but are not limited to, terephthalic acid, isophthalic acid, diphenyl ether dicarboxylic acid, diphenyl sulfone dicarboxylic acid, diphenyl thioether dicarboxylic acid, biphenyl dicarboxylic acid, 2,2′-bis(4-carboxy)hexafluoropropane, 2,2′-bis(4-carboxy)propane, diphenyl ketone dicarboxylic acid, and the like. These acids can be used singly or in combination of two or more kinds thereof.

The heat-resistant resin containing a nitrogen atom is most preferably a resin having a polyamide imide structure preferably represented by the general formula (2), from the viewpoint that the resin composition undergoes a smaller change in quality when stored at room temperature, and that the long-time storage at room temperature has a smaller influence on the spinning characteristics. Having both an amide structure and an imide structure is advantageous in having good compatibility with (b) the solvent and (c) the surfactant having a fluoroalkyl group, and in being inhibited from generating a bead even after the long-term room-temperature storage of the composition.

In a still more preferable mode, R³ in the general formula (2) has a residue of 3,4′-diaminodiphenyl ether, 4,4′-diaminodiphenyl ether, 3,4′-diaminodiphenyl methane, 4,4′-diaminodiphenyl methane, 3,4′-diaminodiphenyl sulfone, 4,4′-diaminodiphenyl sulfone, 3,4′-diaminodiphenyl sulfide, or 4,4′-diaminodiphenyl sulfide, or a structure represented by the following general formula (6) or the general formula (7).

Because of making it possible to obtain a fiber with a small diameter during spinning, it is preferable that 30 mol % or more, more preferably 50 mol % or more, of each of R¹ in the general formula (1), R³ in the general formula (2), R⁵ in the general formula (3), R⁶ in the general formula (3), R⁷ in the general formula (4), R⁸ in the general formula (4), and R⁹ in the general formula (5) has a structure represented by the following general formula (6) or the general formula (7), or is typically a structure represented by the general formula (6) or the general formula (7).

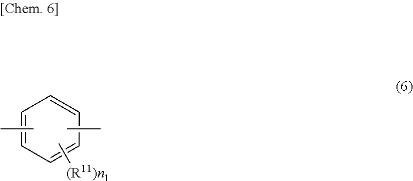

In the general formula (6), R¹¹ represents a C₁₋₆ monovalent group, and is at an ortho position with respect to the main chain of the polymer. n₁ represents an integer of 1 to 4, and is preferably 1 or 2.

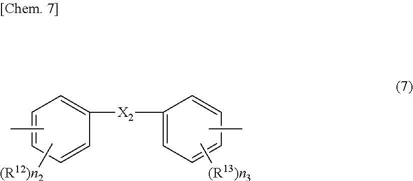

In the general formula (7), R¹² and R¹³ each independently represent a C₁₋₆ monovalent group, and is at an ortho position with respect to the main chain of the polymer. n₂ and n₃ each independently represents an integer of 1 to 4, and is preferably 1 or 2. In addition, X₂ represents at least one selected from a single bond, —O—, —S—, —CH₂—, —C(CH₃)₂—, or —C(CF₃)₂—.

Preferable examples of R¹¹ to R¹³ include, but are not limited to, a methyl group, ethyl group, propyl group, butyl group, hexyl group, cyclohexyl group, and the like. A methyl group and an ethyl group are more preferable.

Still more preferable concrete examples of a structure represented by the general formula (6) or (7) include a structure represented below.

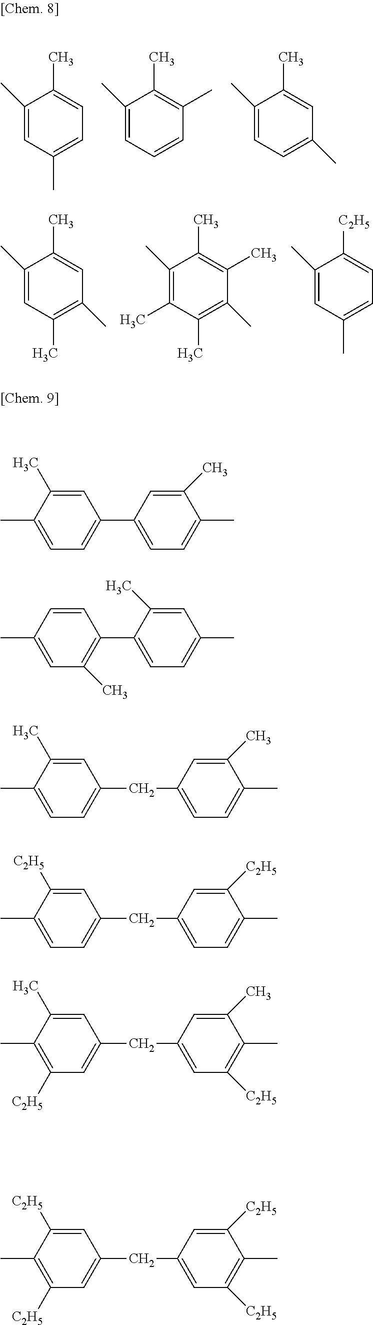

A resin having a structure represented by these general formulae (1) to (5) does not involve dehydration ring closure under high temperature heating. This makes it possible to inhibit a fiber from being shrunk owing to dehydration ring closure, and to obtain a non-woven fabric having higher shape stability.

A resin having a structure represented by the general formulae (1) to (5) is obtained by causing a reaction between a diamine, a diisocyanate that gives the same diamine residue, or a trimethylsilylated diamine that gives the same diamine residue and a tetracarboxylic acid derivative, tricarboxylic derivative, dicarboxylic derivative, or diisocyanate in a known bipolar solvent, such as N-methylpyrrolidone or dimethyl acetamide. The reaction temperature is suitably selected from the range of from −5 to 80° C. in the case of a resin having a structure represented by the general formula (3) or (4). In addition, the reaction temperature is suitably selected from the range of from −5 to 250° C. in the case of a resin having a structure represented by the general formula (1), (2), or (5).

An organic solvent to be used as a reaction solvent is not limited to any particular organic solvent as long as a resin is dissolved in the solvent. The solvent is commonly preferably an aprotic polar solvent. Examples include diphenyl sulfone, dimethyl sulfoxide, sulfolane, dimethyl sulfone, N,N-dimethyl formamide, N,N-dimethyl acetamide, N,N-dimethylisobutyl amide, 3-methoxy-N,N-dimethyl propaneamide, 3-butoxy-N,N-dimethyl propaneamide, N-methyl-2-pyrrolidone, diethyl sulfone, diethyl sulfoxide, 1,4-dimethyl bendazolidinone, hexamethyl triamide, 1,3-dimethyl imidazolidinone, and the like. Additional examples include: ketone solvents having a high boiling point, such as cyclohexanone; ether solvents, such as ethylene glycol dimethyl ether, diethylene glycol dimethyl ether, diethylene glycol methylethyl ether, diethylene glycol diethyl ether, propylene glycol dimethyl ether, propylene glycol methylethyl ether, propylene glycol diethylether, dipropylene glycol dimethyl ether, dipropylene glycol methylethyl ether, and dipropylene glycol diethyl ether. To these, aromatic hydrocarbon solvents, such as toluene and xylene, and ester solvents, such as propylene glycol monomethyl ether acetate and methyl-methoxy butanol acetate, can be added.

The amount of the solvent to be used for polycondensation is preferably 50 parts by weight or more, more preferably 100 parts by weight or more, with respect to 100 parts by weight of all the monomers. Having a solvent in an amount of 50 parts by weight or more with respect to the weight of all the monomers facilitate an operation such as stirring, and facilitate the smooth progress of the polycondensation reaction. On the other hand, the amount is preferably 500 parts by weight or less, more preferably 250 parts by weight or less. Having the amount in 500 parts by weight or less increases the concentration of the monomers in the solvent, and enhances the rate of polymerization, thus making it possible to easily obtain a high molecular weight polymer having a weight average molecular weight of 10,000 or more.

The weight average molecular weight of the resin in the present invention is preferably in the range of from 5,000 to 300,000, particularly preferably in the range of from 10,000 to 200,000. In this regard, the weight average molecular weight in the present invention refers to a value determined as follows: lithium chloride at a concentration of 1 M is added to a solvent mixture of NMP/H₃PO₄; using the resulting solvent, the molecular weight of the resin is measured by gel permeation chromatography (GPC); and the value measured is used to calculate the weight average molecular weight using a calibration curve of standard polystyrene.

### (a-2) Precursor of Heat-Resistant Resin Containing Nitrogen Atom

Preferable examples of a precursor of a heat-resistant resin containing a nitrogen atom include a polyimide precursor, polyamide imide precursor, polyazole precursor, and the like. In a case in which any of these precursors is used, a heat treatment at 120 to 500° C. is desired for dehydration ring closure after spinning.

Specifically, the resin has a structure represented by the following general formulae (8) to (10).

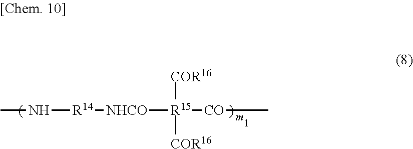

In the general formula (8), R¹⁴ represents a C₂₋₅₀ divalent group. R¹⁵ represents a C₄₋₅₀ tetravalent group. R¹⁶ represents at least one selected from OH, OR¹⁷, or O⁻R¹⁸⁺. R¹⁷ represents a C₁₋₁₀ monovalent group. R¹⁸⁺ represents a monovalent metal cation or ammonium ion. m₆ represents an integer of 1 to 10,000.

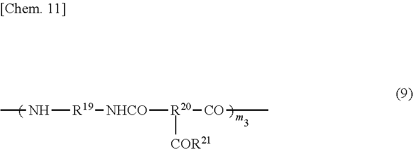

In the general formula (9), R¹⁹ represents a C₂₋₅₀ divalent group. R²⁰ represents a C₄₋₅₀ trivalent group. R²¹ represents at least one selected from OH, OR²², or O⁻R²³⁺. R²² represents a C₁₋₁₀ monovalent group. R²³⁺ represents a monovalent metal cation or ammonium ion. m₇ represents an integer of 1 to 10,000.

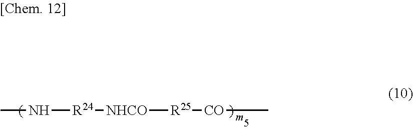

In the general formula (10), R²⁴ represents a C₂₋₅₀ divalent group. R²⁵ represents a C₄₋₅₀ trivalent group. m₈ represents an integer of 1 to 10,000.

In this regard, R¹⁴, R¹⁵,R¹⁷, R¹⁹, R²⁰, R²², R²⁴ and R²⁵ are each typically a residue of an aliphatic hydrocarbon, aromatic hydrocarbon, or nitrogen-containing aromatic hydrocarbon, and in addition, encompass: these residues bound via a linking group, such as a single bond, ether bond, thioether bond, ester bond, ketone bond, or sulfone bond; and the same residue except that part of the hydrogens thereof is/are each replaced with a monovalent functional group, such as an alkyl group, halogenated alkyl group, oxyalkyl group, oxyaryl group, nitro group, cyano group, or halogen.

A structure represented by the general formula (8) is a structural unit of a polyimide precursor. A structure represented by the general formula (9) is a structural unit of a polyamide imide precursor. A structure represented by the general formula (10) is a structural unit of a polyazole precursor.

In the general formula (8) and the general formula (9), R¹⁴ and R¹⁹ each represent a diamine residue. Examples of an amine component that gives a diamine residue include the same components as in the above description of R¹ in the general formula (1).

In the general formula (10), R²⁴ represents a diamine residue. Examples of an amine component that gives a diamine residue include the same components as in the above description of R¹⁰ in the general formula (5).

In the general formula (8), R¹⁵ represents a tetracarboxylic residue. Examples of an acid component that gives a tetracarboxylic residue include the same components as in the above description of R² in the general formula (1).

In the general formula (9), R²⁰ represents a tricarboxylic residue. Examples of an acid component that gives a tricarboxylic residue include the same components as in the above description of R⁴ in the general formula (2).

In the general formula (10), R²⁵ represents a dicarboxylic residue. Examples of an acid component that gives a dicarboxylic residue include the same components as in the above description of R⁹ in the general formula (5).

R¹⁷ and R²² in the general formula (8) and the general formula (9) are each preferably, but not limited to, a methyl group, ethyl group, propyl group, isopropyl group, butyl group, isobutyl group, t-butyl group, pentyl group, hexyl group, cyclohexyl group, or the like from the viewpoint of inhibiting the fiber from being cracked by shrinkage during dehydration ring closure. These groups can be used singly or in combination of two or more kinds thereof.

Concrete examples of R¹⁸⁺ and R²³⁺ in the general formula (8) and the general formula (9) include, but are not limited to, a sodium ion, potassium ion, lithium ion, and the like. Concrete examples of the ammonium ion include, but are not limited to; an ion formed by adding hydrogen to a trialkyl amine, such as trimethyl amine, triethyl amine, or triisopropanol amine; an ion formed by adding hydrogen to a heterocycle-containing monoamine, such as pyridine, imidazole, or piperidine; and a quaternary ammonium ion, such as tetramethyl ammonium or tetrabutylammonium. These metal cations and ammonium ions can be used singly or in combination of two or more kinds thereof.

Because of making it possible to obtain a fiber with a small diameter by spinning, it is preferable that 30 mol % or more, more preferably 50 mol % or more, of each of R¹⁴ in the general formula (8), R¹⁹ in the general formula (9), and R²⁴ in the general formula (10) is a group selected from: a group having a structure represented by the above-described general formula (6) or the general formula (7); and a structure typically represented by the general formula (6) or the general formula (7).

### (a-3) Heat-Resistant Resin Having, in Main Chain, Group Selected from the Group Consisting of Ether Group, Ketone Group, Sulfone Group, and Sulfide Group

The heat-resistant resin having, in the main chain, a group selected from a ketone group, sulfone group, and sulfide group refers to, for example, a resin wherein, via any of these linking groups, an aromatic ring, such as a phenyl group or a naphthyl group, and a heterocycle are linked to form the main chain of the polymer, and wherein the resin has a 5% weight loss temperature of 200° C. or more.

Preferable examples of the heat-resistant resin having, in the main chain, at least one linking group selected from ketone group, sulfone group, or sulfide group include polyether ketone, polyether ether ketone, polyether sulfone, polyphenylene sulfide, or the like.

### (a-4) Precursor of Heat-Resistant Resin Having, in Main Chain, Group Selected from the Group Consisting of Ether Group, Ketone Group, Sulfone Group, and Sulfide Group

Preferable examples of the precursor of a heat-resistant resin having, in the main chain, a group selected from the group consisting of ether group, ketone group, sulfone group, and sulfide group include polyether ketone precursor, polyether ether ketone precursor, polyether sulfone precursor, polyphenylene sulfide precursor, and the like. In a case in which any of these precursors is used, the precursor can be converted to the corresponding heat-resistant resin through a heat treatment performed at 120 to 500° C. for dehydration ring closure after spinning.

### (b) Solvent

(b) the solvent to be used for a resin composition according to the present invention is not limited to any particular solvent as long as the solvent can dissolve a resin of the component (a). A solvent used as a reaction solvent during the production of the resin can also be used directly.

When this is done, a poor solvent, in addition to the above-described reaction solvent, may be used to the extent that no resin is precipitated. In this case, examples of the solvent to be used include, but are not limited to; ether solvents, such as ethylene glycol monomethyl ether, ethylene glycol monoethyl ether, propylene glycol monomethyl ether, propylene glycol monoethyl ether, ethylene glycol dimethyl ether, ethylene glycol diethyl ether, ethylene glycol dibutyl ether, diethylene glycol diethyl ether, diethylene glycol dimethyl ether, and diethylene glycol methylethyl ether; ester solvents, such as ethylene glycol monoethyl ether acetate, propylene glycol monomethyl ether acetate, propyl acetate, butyl acetate, isobutyl acetate, 3-methoxybutyl acetate, 3-methyl-3-methoxybutyl acetate, methyl lactate, ethyl lactate, and butyl lactate; ketones such as acetylacetone, methylpropyl ketone, methylbutyl ketone, methylisobutyl ketone, cyclopentanone, and 2-heptanone; alcohols, such as butyl alcohol, isobutyl alcohol, pentanol, 4-methyl-2-pentanol, 3-methyl-2-butanol, 3-methyl-3-methoxy butanol, and diacetone alcohol; aromatic hydrocarbons, such as toluene and xylene; water; and the like. These can be used singly or in mixture.

### (c) Surfactant Having Fluoroalkyl Group

A resin composition according to the present invention contains (c) the surfactant having a fluoroalkyl group, whereby the surface tension of the resin composition is decreased, thus stabilizing the spinning. This makes it possible to inhibit the generation of “beads” that are each a bumpy defect at which the fiber diameter abruptly becomes larger.

The fluoroalkyl group is a group containing a perfluoro group, and the number of carbons of the perfluoro group is preferably 3 or more, more preferably 4 or more, from the viewpoint of increasing the effect of decreasing the surface tension. In addition, the number is preferably 12 or less, more preferably 8 or less, from the viewpoint of making it possible to generate suitable electrostatic repulsion during electrospinning, and adjust the fiber diameter within a more preferable range.

The number of fluoroalkyl groups contained in one molecule of a compound that is a surfactant is preferably 1 to 3, more preferably 1 to 2.

From the viewpoint of making it possible to further inhibiting the generation of beads, it is preferable to use (c) the surfactant having a fluoroalkyl group, and having at least one group selected from an oxyethylene group, oxypropylene group, or group containing quaternary nitrogen. These groups conceivably interact with a carbonyl group or nitrogen of the resin, and thus, contribute to stabilization during spinning.

Concrete examples of preferable groups as an oxyethylene group and an oxypropylene group include a group in which n₄ and n₅ in a structure represented by the following general formula (11) and the general formula (12) are each 2 to 20, more preferably 2 to 11.

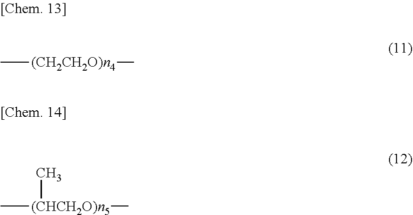

Examples of the group containing quaternary nitrogen include a quaternary ammonium structure, an amine oxide structure, and the like. An amine oxide structure is more preferable from the viewpoint of decreasing the beads.

Furthermore, in respect of electrospinning, specifically from the viewpoint of promoting the division of the liquid by electrostatic repulsion during spinning, and contributing to making the fiber diameter smaller, it is preferable to use (c) the surfactant having a fluoroalkyl group, and having at least one structure selected from carboxyl group, sulfone group, hydroxyl group, carboxylate, sulfonate, or salt of a phenolic hydroxyl group. More preferably, (c) the surfactant having a fluoroalkyl group has at least one structure selected from carboxyl group or hydroxyl group.

The surfactant having a fluoroalkyl group, and having at least one group selected from oxyethylene group, oxypropylene group, or group containing quaternary nitrogen and the surfactant having a fluoroalkyl group, and having at least one structure selected from carboxyl group, sulfone group, hydroxyl group, carboxylate, sulfonate, or a salt of a phenolic hydroxyl group can be used preferably in combination.

In addition, from the viewpoint of further decreasing beads, (c) the surfactant having a fluoroalkyl group preferably does not have a structure in which repeating units containing a fluoroalkyl group are linked.

Here, a structure in which repeating units containing a fluoroalkyl group are linked is a structure obtained by performing polymerization reaction, such as addition polymerization or polycondensation, to link 5 or more monomers that are each a compound having a fluoroalkyl group. Examples of such a structure include an oligomer or a polymer in which 5 or more repeating units having a fluoroalkyl group in the side chain, as represented by the formula below, are repeated.

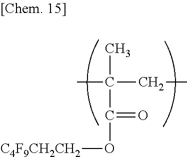

On the other hand, neither a structure containing, in one molecule, a plurality of fluoroalkyl groups that are not in the form of repeating units, nor a structure containing a repeating structure in one molecule, but containing no fluoroalkyl group therein, for example, as each illustrated in the formulae below, falls under a structure in which repeating units containing a fluoroalkyl group are linked.

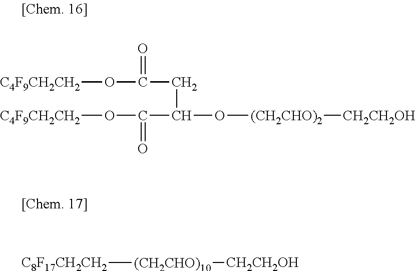

Preferable examples of (c) the surfactant having a fluoroalkyl group include a compound represented below.

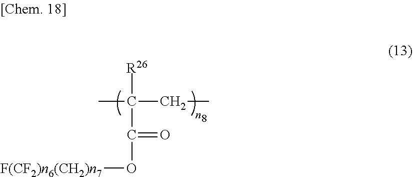

In the general formula (13), R²⁶ represents a C₁₋₆ monovalent group. n₆ represents an integer of 1 to 15, n⁷ represents an integer of 1 to 4, and n₈ represents an integer of 2 to 10,000.

[Chem. 19]

F(CF₂)n₉(CH₂)n₁₀-Y₁ (14)

In the general formula (14), n₉ represents an integer of 1 to 15, and n₁₀ represents an integer of 1 to 4. Y₁ represents a group selected from carboxyl group, sulfonic group, hydroxyl group, carboxylate structure, sulfonate structure, and structure of a salt of a phenolic hydroxyl group.

[Chem. 20]

F(CF₂)n₁₁(CH₂)n₁₂-(CH₂CH₂O)n₁₃CH₂CH₂—Y₂ (15)

In the general formula (15), n₁₁ represents an integer of 1 to 15, n₁₂ represents an integer of 1 to 4, and n₁₃ represents an integer of 1 to 20. Y₂ represents a group selected from carboxyl group, sulfonic group, and hydroxyl group, and encompasses a metal salt, such as an alkali metal salt or an alkaline earth metal salt of such a group.

[Chem. 21]

F(CF₂)n₁₄(CH₂)n₁₅-(CH₂ CH₂O)n₁₆-CH₂CH₂—(CH₂)n₁₇(CF₂)n₁₈F (16)

In the general formula (16), n₁₄ and n₁₅ each independently represent an integer of 1 to 15, n₁₅ and n₁₇ each independently represent an integer of 1 to 4, and n₁₆ represents an integer of 1 to 20.

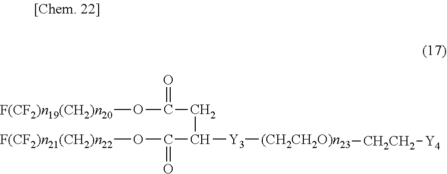

In the general formula (17), n₁₉ and n₂₁ each independently represent an integer of 1 to 15, n₂₀ and n₂₂ each independently represent an integer of 1 to 4, and n₂₃ represents an integer of 1 to 20. Y₃ is a direct binding, ether group, or thioether group. Y₄ represents a group selected from carboxyl group, sulfonic group, and hydroxyl group, and encompasses a metal salt, such as an alkali metal salt or an alkaline earth metal salt of such group.

[Chem. 23]

F(CF₂)n₂₄(CH₂)n₂-Y₅—(CH₂)n₂₆-Y₆ (18)

In the general formula (18), n₂₄ represents an integer of 1 to 15, n₂₅ represents an integer of 1 to 4, and n₂₆ represents an integer of 1 to 8. Y₅ is a direct binding, ether group, or thioether group. Y₆ represents a group selected from carboxyl group, sulfonic group, and hydroxyl group, and encompasses a metal salt, such as an alkali metal salt or an alkaline earth metal salt of such a group.

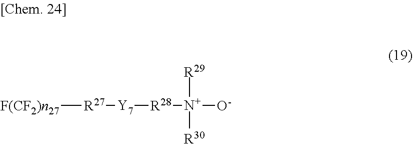

In the general formula (19), R²⁷ and R²⁸ each independently represent a C₁₋₆ divalent group. R²⁹ and R³⁰ each independently represent a C₁₋₆ monovalent group. Y₇ represents a group selected from a direct binding, ether group, thioether group, —NH—, and —NR³¹—. R³¹ represents a C₁₋₆ monovalent group. n₂₇ represents an integer of 1 to 15.

In the general formulae (13) to (19), n₆, n₉, n₁₁, n₁₄, n₁₈, n₁₉, n₂₁, n₂₄, and n₂₇ are each preferably 3 or more, more preferably 4 or more, from the viewpoint of increasing the effect of decreasing the surface tension. In addition, from the viewpoint of making the fiber diameter smaller, the number is preferably 12 or less, more preferably 8 or less.

In the general formulae (13) to (18), n₇, n₁₀, n₁₂, n₁₅, n₁₇, n₂₀, n₂₂, and n₂₅ are each preferably 2 from the viewpoint of the effect of decreasing the surface tension.

In the general formula (18), n₂₀ is preferably 2 to 4 from the viewpoint of the effect of decreasing the surface tension.

In the general formulae (15) to (17), n₁₃, n₁₆, and n₂₃ are each preferably 2 to 15, more preferably 2 to 11, from the viewpoint of decreasing the beads.

In the general formulae (14), (15), (17), and (18), Y₁, Y₂, Y₄, and Y₆ are each preferably a group selected from carboxyl group and hydroxyl group from the viewpoint of making the fiber diameter smaller.

In the general formula (19), R²⁷ and R²⁸ are each preferably a C₁₋₄ group from the viewpoint of the effect of decreasing the surface tension. In addition, from the viewpoint of making the fiber diameter smaller, R²⁷ is more preferably a C₁₋₄ group containing a hydroxyl group or a carboxyl group in the side chain.

In the general formula (19), R²⁹, R³⁰, and R³¹ are each preferably a C₁₋₃ group from the viewpoint of the effect of decreasing the surface tension. Preferable concrete examples include a methyl group, ethyl group, and isopropyl group.

In this regard, R²⁶ to R³¹ are each typically a residue of an aliphatic hydrocarbon, aromatic hydrocarbon, or nitrogen-containing aromatic hydrocarbon, and in addition, encompass: these residues bound via a linking group, such as a single bond, ether bond, thioether bond, ester bond, ketone bond, or sulfone bond; and the same residue except that part of the hydrogens thereof is/are each replaced with a monovalent functional group, such as an alkyl group, oxyalkyl group, oxyaryl group, nitro group, or cyano group.

Particularly preferable concrete examples of (c) the surfactant having a fluoroalkyl group include a compound represented below.

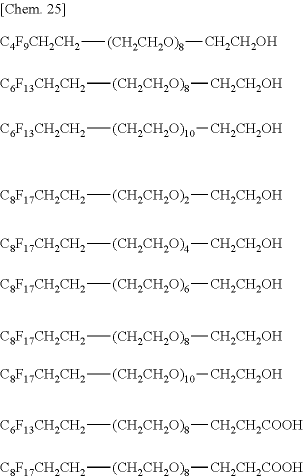

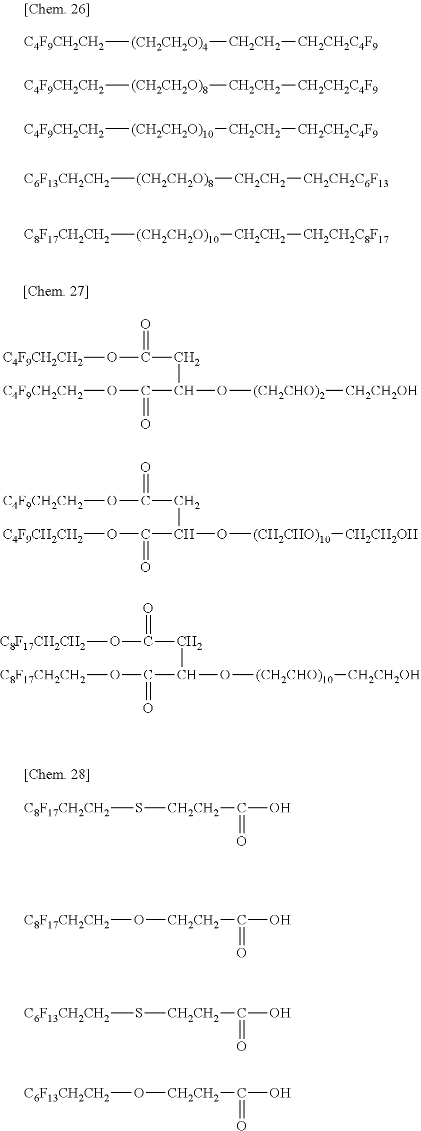

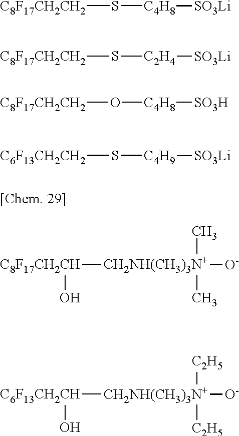

In a composition according to the present invention for forming a non-woven fabric by an electrospinning method, the amount of (c) the surfactant having a fluoroalkyl group in the composition is preferably 0.3 to 10 mass %, more preferably 0.5 to 5 mass %, still more preferably 1 to 3 mass %. Bringing this amount to a value equal to or greater than the lower limit makes it possible to further inhibit the frequency with which bumpy defects are generated in the fiber during electrospinning. In addition, bringing this amount to a value equal to or smaller than the upper limit brings electrostatic repulsion during electrospinning within a suitable range, and makes it easier to obtain a fiber having a smaller fiber diameter.

### Non-Woven Fabric

A non-woven fabric according to the present invention include: (a) at least one heat-resistant resin or a precursor thereof, the heat-resistant resin being selected from the group consisting of a heat-resistant resin containing a nitrogen atom and a heat-resistant resin containing, in the main chain, at least one group selected from the group consisting of ether group, ketone group, sulfone group, and sulfide group; and (c) a surfactant having a fluoroalkyl group. Here, the details of the component (a) and the component (c) are as described above.

In addition, in the case of a non-woven fabric for which a precursor of a heat-resistant resin is used, the precursor can further be converted to a heat-resistant resin through a thermal or chemical treatment, such as cross-linking, thermal ring closure, or chemical ring closure.

The non-woven fabric containing the component (c) makes it possible that the hydrophobic interaction due to the fluoroalkyl groups unevenly distributed in the surface of the fiber enhances the binding at the portion of contact between fibers, and increases the toughness of the non-woven fabric. In addition, the non-woven fabric formed and then heat-treated has an advantage in that, through the fusion of the fluoroalkyl group, the polymer fibers are bound more firmly therebetween.

Such a non-woven fabric can be obtained, for example, by spinning a product formed by melting, or dissolving in a solvent, a resin composition including: (a) at least one heat-resistant resin or a precursor thereof, the heat-resistant resin being selected from the group consisting of a heat-resistant resin containing a nitrogen atom and a heat-resistant resin containing, in the main chain, at least one group selected from an ether group, ketone group, sulfone group, and sulfide group; (b) a solvent; and (c) a surfactant having a fluoroalkyl group.

Using an electrospinning method as a spinning method allows the liquid to be divided during spinning, affording a non-woven fabric composed of a fiber having a smaller fiber diameter, and thus, is preferable. That is, it is preferable to form a non-woven fabric by spinning the above-mentioned resin composition using an electrospinning method.

An electrospinning method used here is a spinning method in which a high voltage is applied to a polymer solution, and the polymer solution thus electrified is sprayed onto an electrically grounded counter electrode, whereby microfiber is obtained. Examples of an electrospinning device to be used in the present invention include, but are not limited particularly to: a device in which a polymer solution is discharged through a nozzle protruding like a syringe; a device in which a thin film polymer solution formed on a rotating roller or ball is electrified, whereby microfiber is discharged through a discharge outlet; and the like. The solution is discharged with a voltage applied to the discharge outlet. An aluminum foil or a release paper as a base material is preliminarily bonded to the electrically grounded counter electrode. A non-woven fabric is deposited on the base material.

Furthermore, a non-woven fabric formed from a resin composition, such as in the general formulae (1) to (5), does not require any heating treatment for dehydration ring closure after spinning, and can be extremely simply obtained as a non-woven fabric having excellent heat resistance and mechanical characteristics.

On the other hand, a non-woven fabric formed using a precursor of a heat-resistant resin often has excellent spinnability because a precursor of a heat-resistant resin usually has a high affinity for a solvent. It is possible to utilize this property to obtain a non-woven fabric made up of fine fibers. Then, converting the precursor of a heat-resistant resin to a heat-resistant resin makes it possible to obtain a non-woven fabric having excellent heat resistance and mechanical characteristics.

A non-woven fabric having excellent mechanical strength is strong against corruption, and is not corrupted when a battery is assembled, or when a change in the volume of an electrode is caused during charging/discharging. From such a viewpoint, the tensile strength of the non-woven fabric is preferably 1.0 N/cm or more, more preferably 1.5 N/cm or more, still more preferably 2.0 N/cm or more, particularly preferably 2.5 N/cm or more. The upper limit of the tensile strength is not limited to any particular value, and is preferably 5.0 N/cm or less.

The fiber diameter of the non-woven fabric is preferably 3 μm or less, more preferably 1.5 μm or less, still more preferably 1 μm or less. Keeping dense and tough, the non-woven fabric having a smaller fiber diameter can have an enhanced porosity, and securely have high gas permeability and liquid permeability.

A fiber diameter as used herein is determined as follows: a non-woven fabric is observed at a suitable magnification (for example, 10,000 times) under a scanning electron microscope (SEM); 30 fibers are randomly selected within the field of view; the width of each fiber is measured; and the arithmetic average of the measurements is taken as a fiber diameter.

### Applications of Non-Woven Fabric

A non-woven fabric according to an embodiment of the present invention can be suitably used for: a separator for an electricity storage element, such as a secondary battery or an electric double layer capacitor; or a fiber product, such as a sound absorbing material, electromagnetic wave shielding material, separation filter, or heat resistant bag filter. In particular, in a case in which the non-woven fabric is used for a separator for an electricity storage element, such a separator has high heat resistance, and thus, can enhance the safety of the electricity storage element.

A secondary battery or an electric double layer capacitor according to an embodiment of the present invention has the above-mentioned separator as a separator between a cathode and an anode. Such a secondary battery or an electric double layer capacitor can be obtained by stacking a plurality of electrodes with the above-described separator therebetween, packing the stack together with an electrolyte in an exterior material such as a metal case, and sealing the material.

### EXAMPLES

Below, the present invention will be described with reference to Examples and technologies, and the present invention should not be limited to these Examples.

### Synthesis Example 1 (Polyether Sulfone Solution)

Under a dry nitrogen gas stream, 22.8 g (0.1 mol) of bisphenol A (manufactured by Tokyo Chemical Industry Co., Ltd.), 28.7 g (0.1 mol) of bis(4-chlorophenyl)sulfone (manufactured by Tokyo Chemical Industry Co., Ltd.), 17.3 g (0.125 mol) of potassium carbonate (manufactured by Tokyo Chemical Industry Co., Ltd.), 150 g of N,N-dimethyl acetamide (DMAc, manufactured by Tokyo Chemical Industry Co., Ltd.), and 80 g of toluene (manufactured by Tokyo Chemical Industry Co., Ltd.) were added to a 500 mL flask with a Dean-Stark trap. The resulting mixture was refluxed with stirring for 6 hours to remove water. Then, excessive of toluene was evaporated under reduced pressure, the remaining mixture was stirred at 160° C. for 12 hours, and then the reaction liquid was cooled to 100° C. To the reaction liquid, 100 g of chlorobenzene (manufactured by Tokyo Chemical Industry Co., Ltd.) was added, and the precipitate was filtered off. The filtrate was neutralized with acetic acid (manufactured by Tokyo Chemical Industry Co., Ltd.), and then added to 3 L of liquid of pure water/methanol (manufactured by Tokyo Chemical Industry Co., Ltd.) at 1/1 (a mass ratio) to precipitate a polymer, which was filtered off. The precipitate was further dispersed in 3 L of liquid of pure water/methanol at 1/1 (a mass ratio), filtered, then dispersed in 3 L of pure water, filtered, and finally refluxed in boiling water for 1 hour. The powder filtered off after the reflux was dried under reduced pressure at 100° C. for 72 hours, and 14 g of the polymer solid dried was dissolved in 26 g of DMAc to obtain a polyether sulfone solution (PES-01) having a mass concentration of 35%.

### Synthesis Example 2 (Polyimide Precursor Solution)

Under a dry nitrogen gas stream, 10.8 g (0.1 mol) of paraphenylene diamine (PDA, manufactured by Tokyo Chemical Industry Co., Ltd.) was dissolved in 50 g of DMAc in a 200 mL flask. To the resulting solution, 27.9 g (0.095 mol) of 3,3′,4,4′-biphenyltetracarboxylic dianhydride (BPDA, manufactured by Tokyo Chemical Industry Co., Ltd.) together with 21.9 g of DMAc was added, and the resulting mixture was stirred at 60° C. for 5 hours, and then cooled to room temperature to obtain a polyimide precursor solution (PAA-01) having a polymer concentration of 35 mass %.

### Synthesis Example 3 (Polyimide Solution)

Under a dry nitrogen gas stream, 33.0 g (0.09 mol) of 2,2-bis(3-amino-4-hydroxyphenyl)hexafluoropropane (BAHF, manufactured by Tokyo Chemical Industry Co., Ltd.) was dissolved in 100 g of N-methyl-2-pyrrolidone (NMP, manufactured by Tokyo Chemical Industry Co., Ltd.) in a 300 mL flask. To the resulting solution, 31.0 g (0.1 mol) of 3,3′,4,4′-diphenyl ether tetracarboxylic dianhydride (ODPA, manufactured by Tokyo Chemical Industry Co., Ltd.) together with 12.8 g of NMP was added, and the resulting mixture was stirred at 40° C. for 2 hours. The mixture was further stirred at 200° C. for 6 hours, and then cooled to room temperature to obtain a polyimide solution (PI-01) having a polymer concentration of 35 mass %.

### Synthesis Example 4 (Polyamide Imide Precursor Solution)

Under a dry nitrogen gas stream, 20.0 g (0.1 mol) of diaminodiphenyl ether (DAE, manufactured by Tokyo Chemical Industry Co., Ltd.) and 11.1 g (0.11 mol) of triethylamine (TEA, manufactured by Tokyo Chemical Industry Co., Ltd.) were dissolved in 100 g of NMP in a 300 mL flask. To the resulting solution, 20.0 g (0.095 mol) of anhydrous trimellitic chloride (TMC, manufactured by Tokyo Chemical Industry Co., Ltd.) together with 20 g of NMP was added, and the resulting mixture was stirred at 0° C. for 5 hours. On completion of the stirring, the triethylamine hydrochloride precipitated in the liquid was filtered off, the filtrate solution was added to 2 L of water, and the precipitation of the polymer solid was collected by filtration. Furthermore, the polymer solid collected was washed with 2 L of water three times, and dried at 50° C. for 72 hours using a vacuum dryer. In 13 g of DMAc, 7 g of the polymer solid dried was dissolved to obtain a polyamide imide precursor solution (PAIA-01) having a polymer concentration of 35 mass %.

### Synthesis Example 5 (Polyamide Imide Solution)

Under a dry nitrogen gas stream, 5.23 g (0.03 mol) of 2,4-toluene diisocyanate (TDI, manufactured by Tokyo Chemical Industry Co., Ltd.) and 17.5 g (0.07 mol) of diphenyl methane diisocyanate (MDI, manufactured by Tokyo Chemical Industry Co., Ltd.) were dissolved in 55 g of DMAc in a 300 mL flask. To the resulting solution, 18.3 g (0.095 mol) of trimellitic anhydride (TMA, manufactured by Tokyo Chemical Industry Co., Ltd.) together with 5.67 g of DMAc was added, and the resulting mixture was stirred at 120° C. for 2 hours, at 140° C. for 2 hours, and at 160° C. for 2 hours. After the stirring, the resulting mixture was cooled to room temperature to obtain a polyamide imide solution (PAI-01) having a polymer concentration of 35 mass %.

### Synthesis Example 6 (Polyamide Solution)

Under a dry nitrogen gas stream, 22.2 g (0.1 mol) of isophorone diisocyanate (IHDI, manufactured by Tokyo Chemical Industry Co., Ltd.) was dissolved in 50 g of NMP in a 200 mL flask. To the resulting solution, 16.6 g (0.1 mol) of isophthalic acid (IPA, manufactured by Tokyo Chemical Industry Co., Ltd.) together with 5.71 g of NMP was added, and the resulting mixture was stirred at 200° C. for 6 hours. After the stirring, the resulting mixture was cooled to room temperature to obtain a polyamide solution (PA-01) having a polymer concentration of 35 mass %.

### Synthesis Example 7 (Polyurea Solution)

Under a dry nitrogen gas stream, 10.8 g (0.1 mol) of PDA was dissolved in 50 g of DMAc in a 200 mL flask. To the resulting solution, 21.3 g (0.096 mol) of IHDI together with 9.61 g of DMAc was added, and the resulting mixture was stirred at 40° C. for 6 hours. After the stirring, the resulting mixture was cooled to room temperature to obtain a polyurea solution (PU-01) having a polymer concentration of 35 mass %.

### Synthesis Example 8 (Polybenzoxazole Precursor Solution)

Under a dry nitrogen gas stream, 36.6 g (0.1 mol) of BAHF and 21.2 g (0.21 mol) of TEA were dissolved in 150 g of NMP in a 500 mL flask. To the resulting solution, 28.3 g (0.096 mol) of 4,4′-diphenyl ether dicarboxylic chloride (DEDC, manufactured by Tokyo Chemical Industry Co., Ltd.) together with 44.7 g of NMP was added, and the resulting mixture was stirred at 5° C. for 6 hours. The triethylamine hydrochloride precipitated in the liquid was filtered off, the filtrate solution was added to 2 L of water, and the precipitation of the polymer solid was collected by filtration. Furthermore, the polymer solid collected was washed with 2 L of water three times, and dried at 50° C. for 72 hours using a vacuum dryer. In 26 g of DMAc, 14 g of the polymer solid dried was dissolved to obtain a polybenzoxazole precursor solution (PBOA-01) having a mass concentration of 35 mass %.

### Synthesis Example 9 (Polybenzoxazole Solution)

Under a dry nitrogen gas stream, 36.6 g (0.1 mol) of BAHF and 21.2 g (0.21 mol) of TEA were dissolved in 200 g of NMP in a 500 mL flask. To the resulting solution, 37.7 g (0.096 mol) of 2,2′-bis(4-carboxyphenyl)hexafluoropropane (6FDC, manufactured by Tokyo Chemical Industry Co., Ltd.) together with 22.9 g of NMP was added, and the resulting mixture was stirred at 40° C. for 2 hours. On completion of the stirring, the triethylamine hydrochloride precipitated in the liquid was filtered off, the filtrate solution was added to 2 L of water, and the precipitation of the polymer solid was collected by filtration. Furthermore, the polymer solid collected was washed with 2 L of water three times, and dried at 50° C. for 72 hours using a vacuum dryer. In 52 g of NMP, 28 g of the polymer solid dried was dissolved, and the resulting solution was stirred at 200° C. for 6 hours, and then cooled to room temperature to obtain a polybenzoxazole solution (PBO-01) having a polymer concentration of 35 mass %.

### Synthesis Example 10 (Polybenzothiazole Precursor Solution)

Under a dry nitrogen gas stream, 24.5 g (0.1 mol) of 2,5-dimercapto-1,4-phenylene diamine dihydrochloride (SHPDA, manufactured by Tokyo Chemical Industry Co., Ltd.) and 41.4 g (0.41 mol) of TEA were dissolved in 100 g of NMP in a 300 mL flask. To the resulting solution, 28.3 g (0.096 mol) of DEDC together with 58.4 g of NMP was added, and the resulting mixture was stirred at 5° C. for 6 hours. The triethylamine hydrochloride precipitated in the liquid was filtered off, the filtrate solution was added to 2 L of water, and the precipitation of the polymer solid was collected by filtration. Furthermore, the polymer solid collected was washed with 2 L of water three times, and dried at 50° C. for 72 hours using a vacuum dryer. In 26 g of DMAc, 14 g of the polymer solid dried was dissolved to obtain a polybenzothiazole precursor solution (PBTA-01) having a polymer concentration of 35 mass %.

### Synthesis Example 11 (Polybenzimidazole Precursor Solution)

Under a dry nitrogen gas stream, 21.4 g (0.1 mol) of 3,3′-diaminobenzidine (DABZ, manufactured by Tokyo Chemical Industry Co., Ltd.) and 21.2 g (0.21 mol) of TEA were dissolved in 100 g of NMP in a 300 mL flask. To the resulting solution, 28.3 g (0.096 mol) of DEDC together with 49.1 g of NMP was added, and the resulting mixture was stirred at 5° C. for 6 hours. The triethylamine hydrochloride precipitated in the liquid was filtered off, the filtrate solution was added to 2 L of water, and the precipitation of the polymer solid was collected by filtration. Furthermore, the polymer solid collected was washed with 2 L of water three times, and dried at 50° C. for 72 hours using a vacuum dryer. In 26 g of DMAc, 14 g of the polymer solid dried was dissolved to obtain a 35 mass % polybenzimidazole precursor solution (PBIA-01).

### Synthesis Example 12 (Polyimide Precursor Solution)

Under a dry nitrogen gas stream, 14.0 g (0.07 mol) of DAE and 3.67 g (0.03 mol) of 2,4-diaminotoluene (TDA, manufactured by Tokyo Chemical Industry Co., Ltd.) were dissolved in 70 g of DMAc in a 200 mL flask. To the resulting solution, 27.9 g (0.095 mol) of BPDA together with 14.6 g of DMAc was added, and the resulting mixture was stirred at 60° C. for 5 hours, and then cooled to room temperature to obtain a polyimide precursor solution (PAA-02) having a polymer concentration of 35 mass %.

### Synthesis Example 13 (Polyimide Precursor Solution)

Under a dry nitrogen gas stream, 10.0 g (0.05 mol) of DAE and 10.6 g (0.05 mol) of o-tolidine (o-TODA, manufactured by Tokyo Chemical Industry Co., Ltd.) were dissolved in 70 g of DMAc in a 200 mL flask. To the resulting solution, 20.7 g (0.095 mol) of pyromellitic anhydride (PMDA, manufactured by Tokyo Chemical Industry Co., Ltd.) together with 6.70 g of DMAc was added, and the resulting mixture was stirred at 60° C. for 5 hours, and then cooled to room temperature to obtain a polyimide precursor solution (PAA-03) having a polymer concentration of 35 mass %.

### Synthesis Example 14 (Polyimide Solution)

Under a dry nitrogen gas stream, 9.54 g (0.045 mol) of m-tolidine (m-TODA, manufactured by Tokyo Chemical Industry Co., Ltd.) and 11.2 g (0.045 mol) of 3,3-diaminodiphenyl sulfone (3-DDS, manufactured by Tokyo Chemical Industry Co., Ltd.) were dissolved in 80 g of NMP in a 300 mL flask. To the resulting solution, 31.0 g (0.1 mol) of ODPA together with 10.1 g of NMP was added, and the resulting mixture was stirred at 40° C. for 2 hours. The mixture was further stirred at 200° C. for 6 hours, and then cooled to room temperature to obtain a polyimide solution (PI-02) having a polymer concentration of 35 mass %.

### Synthesis Example 15 (Polyimide Solution)

Under a dry nitrogen gas stream, 12.7 g (0.045 mol) of 4,4′-methylenebis(2-ethyl-6-methylaniline) (MEDX, manufactured by Tokyo Chemical Industry Co., Ltd.) and 11.2 g of 3-DDS (0.045 mol) were dissolved in 80 g of NMP in a 300 mL flask. To the resulting solution, 10.9 g (0.05 mol) of PMDA and 16.1 g (0.05 mol) of 3,3′,4,4′-benzophenonetetracarboxylic dianhydride (BTDA, manufactured by Tokyo Chemical Industry Co., Ltd.) together with 8.51 g of NMP were added, and the resulting mixture was stirred at 40° C. for 2 hours. The mixture was further stirred at 200° C. for 6 hours, and then cooled to room temperature to obtain a polyimide solution (PI-03) having a polymer concentration of 35 mass %.

### Synthesis Example 16 (Polyimide Solution)

Under a dry nitrogen gas stream, 14.9 g (0.06 mol) of 3-DDS and 3.67 g (0.03 mol) of TDA were dissolved in 80 g of NMP in a 300 mL flask. To the resulting solution, 31.0 g (0.1 mol) of ODPA together with 6.04 g of NMP was added, and the resulting mixture was stirred at 40° C. for 2 hours. The mixture was further stirred at 200° C. for 6 hours, and then cooled to room temperature to obtain a polyimide solution (PI-04) having a polymer concentration of 35 mass %.

### Synthesis Example 17 (Polyamide Imide Precursor Solution)

Under a dry nitrogen gas stream, 10.0 g (0.05 mol) of DAE, 10.6 g (0.05 mol) of m-TODA, and 11.1 g (0.11 mol) of triethylamine (TEA, manufactured by Tokyo Chemical Industry Co., Ltd.) were dissolved in 100 g of NMP in a 300 mL flask. To the resulting solution, 20.0 g (0.095 mol) of TMC together with 21.8 g of NMP was added, and the resulting mixture was stirred at 0° C. for 5 hours. On completion of the stirring, the triethylamine hydrochloride precipitated in the liquid was filtered off, the filtrate solution was added to 2 L of water, and the precipitation of the polymer solid was collected by filtration. Furthermore, the polymer solid collected was washed with 2 L of water three times, and dried at 50° C. for 72 hours using a vacuum dryer. In 13 g of DMAc, 7 g of the polymer solid dried was dissolved to obtain a 35 mass % polyamide imide precursor solution (PAIA-02).

### Synthesis Example 18 (Polyamide Imide Solution)

Under a dry nitrogen gas stream, 13.2 g (0.05 mol) of o-tolidine diisocyanate (TODI, manufactured by Tokyo Chemical Industry Co., Ltd.) and 12.5 g (0.05 mol) of MDI were dissolved in 60 g of DMAc in a 300 mL flask. To the resulting solution, 18.3 g (0.095 mol) of TMA together with 6.19 g of DMAc was added, and the resulting mixture was stirred at 120° C. for 2 hours, at 140° C. for 2 hours, and at 160° C. for 2 hours. After the stirring, the resulting mixture was cooled to room temperature to obtain a polyamide imide solution (PAI-02) having a polymer concentration of 35 mass %.

### Synthesis Example 19 (Polyamide Imide Solution)

Under a dry nitrogen gas stream, 25.0 g (0.1 mol) of MDI was dissolved in 60 g of DMAc in a 300 mL flask. To the resulting solution, 18.3 g (0.095 mol) of TMA together with 4.89 g of DMAc was added, and the resulting mixture was stirred at 120° C. for 2 hours, at 140° C. for 2 hours, and at 160° C. for 2 hours. After the stirring, the resulting mixture was cooled to room temperature to obtain a polyamide imide solution (PAI-03) having a polymer concentration of 35 mass %.

### Synthesis Example 20 (Polyamide Solution)

Under a dry nitrogen gas stream, 15.5 g (0.07 mol) of IHDI and 5.23 g (0.03 mol) of TDI were dissolved in 45 g of NMP in a 200 mL flask. To the resulting solution, 16.6 g (0.1 mol) of IPA together with 7.98 g of NMP was added, and the resulting mixture was stirred at 200° C. for 6 hours. After the stirring, the resulting mixture was cooled to room temperature to obtain a polyamide solution (PA-02) having a polymer concentration of 35 mass %.

### Synthesis Example 21 (Polyamide Solution)

Under a dry nitrogen gas stream, 11.1 g (0.05 mol) of IHDI and 8.71 g (0.05 mol) of TDI were dissolved in 45 g of NMP in a 200 mL flask. To the resulting solution, 16.6 g (0.1 mol) of IPA together with 6.28 g of NMP was added, and the resulting mixture was stirred at 200° C. for 6 hours. After the stirring, the resulting mixture was cooled to room temperature to obtain a polyamide solution (PA-03) having a polymer concentration of 35 mass %.

### Synthesis Example 22 (Polyurea Solution)

Under a dry nitrogen gas stream, 14.0 g (0.07 mol) of DAE and 3.67 g (0.03 mol) of TDA were dissolved in 60 g of DMAc in a 200 mL flask. To the resulting solution, 21.3 g (0.096 mol) of IHDI together with 12.4 g of DMAc was added, and the resulting mixture was stirred at 40° C. for 6 hours. After the stirring, the resulting mixture was cooled to room temperature to obtain a polyurea solution (PU-02) having a polymer concentration of 35 mass %.

### Synthesis Example 23 (Polyurea Solution)

Under a dry nitrogen gas stream, 5.4 g (0.05 mol) of PDA and 10.6 g (0.05 mol) of o-TODA were dissolved in 60 g of DMAc in a 200 mL flask. To the resulting solution, 21.3 g (0.096 mol) of IHDI together with 9.27 g of DMAc was added, and the resulting mixture was stirred at 40° C. for 6 hours. After the stirring, the resulting mixture was cooled to room temperature to obtain a polyurea solution (PU-03) having a polymer concentration of 35 mass %.

### Synthesis Example 24 (Surfactant A: Having Structure in which Repeating Units Containing Fluoroalkyl Group Are Linked)

To a 500 ml flask with a reflux condenser, thermometer, stirrer, and dropping funnel, 150 g of xylene was added, and the liquid temperature was kept at 110° C. Under a nitrogen atmosphere, a solution mixture of 60 g (0.18 mol) of 2-(perfluorobutyl)ethyl methacrylate (manufactured by FUJIFILM Wako Chemical Co., Ltd.), 2 g (0.02 mol) of methyl methacrylate (manufactured by Tokyo Chemical Industry Co., Ltd.), 38 g (0.2 mol) of n-butoxyethyl methacrylate (manufactured by Tokyo Chemical Industry Co., Ltd.), and 1 g of PEROCTA 0 (manufactured by NOF Corporation) was added dropwise to xylene over a period of approximately 1 hour. The resulting mixture was allowed to react at 110° C. for 2 hours to obtain the following compound A.

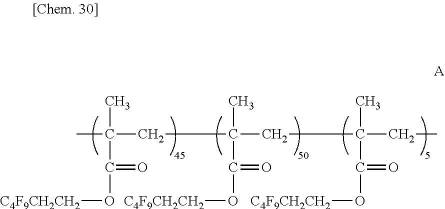

### Synthesis Example 25 (Surfactant B: Containing Fluoroalkyl Group and Oxyethylene Group)

In a 200 ml flask with a stirrer and a dropping funnel, 19.3 g (0.1 mol) of a 28% sodium methoxide methanol solution was added dropwise to a mixture of 26.4 g (0.1 mol) of 1H,1H,2H,2H-nonafluoro-1-hexanol (manufactured by Tokyo Chemical Industry Co., Ltd.) and 16.0 g (0.05 mol) of bis(2-(2-(2-chloroethoxy)ethoxy)ethyl)ether (manufactured by Tokyo Chemical Industry Co., Ltd.) at room temperature. Furthermore, the resulting mixture was heated with stirring at 80° C. for 5 hours. On completion of the reaction, 300 ml of ethyl acetate was added, and the organic layer was washed with 150 ml of a 20% sodium chloride solution three times. The resulting solution was dried over 30.0 g of anhydrous magnesium sulfate, and then, the solvent was evaporated under reduced pressure to obtain the following compound B.

[Chem. 31]

C₄F₉CH₂CH₂—(CH₂CH₂O)₄—CH₂CH₂—CH₂CH₂C₄F₉ B

### Synthesis Example 26 (Surfactant C: Containing Fluoroalkyl Group, Oxyethylene Group, and Hydroxyl Group)

In a 200 ml flask with a stirrer and a dropping funnel, 19.3 g (0.1 mol) of a 28% sodium methoxide methanol solution was added dropwise to a mixture of 46.4 g (0.1 mol) of 1H,1H,2H,2H-heptadecafluoro-1-decanol (manufactured by Tokyo Chemical Industry Co., Ltd.) and 16.9 g (0.1 mol) of 2-(2-(2-chloroethoxy)ethoxy)ethanol (manufactured by Tokyo Chemical Industry Co., Ltd.) at room temperature. Furthermore, the resulting mixture was heated with stirring at 80° C. for 5 hours. On completion of the reaction, 300 ml of ethyl acetate was added, and the organic layer was washed with 150 ml of a 20% sodium chloride solution three times. The resulting solution was dried over 30.0 g of anhydrous magnesium sulfate, and then, the solvent was evaporated under reduced pressure to obtain the following compound C.

[Chem. 32]

C₈F₁₇CH₂CH₂—(CH₂CH₂O)₂—CH₂CH₂OH B

### Synthesis Example 27 (Surfactant D: Containing Fluoroalkyl Group, Oxyethylene Group, and Hydroxyl Group)

In a 200 ml flask with a stirrer and a Dean-stark trap, 26.4 g (0.1 mol) of 1H,1H,2H,2H-nonafluoro-1-hexanol, 6.7 g (0.05 mol) of malic acid (manufactured by Tokyo Chemical Industry Co., Ltd.), 5.0 g of concentrated sulfuric acid, and 100 ml of toluene were preliminarily well mixed, and the resulting mixture was heated under reflux until a theoretical quantity of water (1.8 g) was removed. The mixture was cooled to 60° C., 4 g of lime hydrate was added thereto, and the resulting mixture was stirred at the same temperature for 30 minutes. After the filtration, the toluene was evaporated under reduced pressure to obtain a diester product, [malic di-(1H,1H,2H,2H-nonafluoro-1-hexyl)ester], in the form of a yellow transparent viscous liquid.

In a 200 ml flask with a stirrer and a dropping funnel, 19.3 g (0.1 mol) of a 28% sodium methoxide methanol solution was added dropwise to a mixture of 31.3 g (0.1 mol) of the diester product obtained above and 16.9 g (0.1 mol) of 2-(2-(2-chloroethoxy)ethoxy)ethanol at room temperature. Furthermore, the resulting mixture was heated with stirring at 80° C. for 5 hours. On completion of the reaction, 300 ml of ethyl acetate was added, and the organic layer was washed with 150 ml of a 20% sodium chloride solution three times. The resulting solution was dried over 30.0 g of anhydrous magnesium sulfate, and then, the solvent was evaporated under reduced pressure to obtain the following compound D.

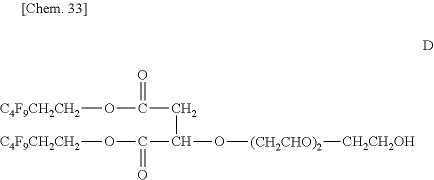

### Synthesis Example 28 (Surfactant E: Containing Fluoroalkyl Group and Carboxyl Group)

To a 1 L flask with a stirrer, a reflux condenser, and a dropping funnel, 57.4 g (0.1 mol) of 1H,1H,2H,2H-heptadecafluorodecyliodide (manufactured by Tokyo Chemical Industry Co., Ltd.), 27.6 g of anhydrous potassium carbonate, and 400 ml of acetone were added and mixed. Then, 16.0 g (0.12 mol) of ethyl 2-mercaptopropionate ester (manufactured by Tokyo Chemical Industry Co., Ltd.) was added dropwise over a period of 10 minutes, and furthermore, the resulting mixture was allowed to react with stirring at room temperature for 5 hours. The resulting reaction mixture was filtered, and then, acetone was removed by distillation. Furthermore, the raw materials and the like were removed by distillation under reduced pressure to obtain an ethyl 1H,1H,2H,2H-heptadecafluorodecylmercaptopropionate ester.

To a 300 ml flask with a stirrer, reflux condenser, and thermometer, 22.0 g of (0.38 mol) of the ethyl 1H,1H,2H,2H-heptadecafluorodecylmercaptopropionate ester obtained, 1.35 g of lithium hydroxide, and 50 ml of water were added, and the resulting mixture was allowed to react with stirring at 80° C. for 4 hours. The reaction liquid was made acidic with 1 N hydrochloric acid, 300 ml of ethyl acetate was then added, and the organic layer was extracted. The organic layer extracted was washed with 150 ml of a 20% sodium chloride solution three times. The resulting solution was dried over 30.0 g of anhydrous magnesium sulfate, and then, the solvent was evaporated under reduced pressure to obtain the following compound E.

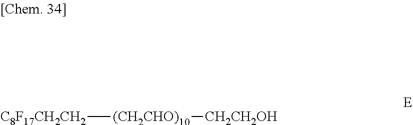

### Synthesis Example 29 (Surfactant F: Containing Fluoroalkyl Group and Sulfonate Structure)

To a 2 L flask with a stirrer, reflux condenser, and thermometer, 480.2 g (1 mol) of 3,3,4,4,5,5,6,6,7,7,8,8,9,9,10,10,10-heptadecafluoro-1-decanethiol (manufactured by Sigma-Aldrich) and 149.8 g (1.1 mol) of 1,4-butanesultone (manufactured by Tokyo Chemical Industry Co., Ltd.) were added, and the resulting mixture was stirred at 120° C. under a nitrogen atmosphere for 4 hours. Then, the reaction liquid was cooled to 25° C., and thereto, 460 g of an aqueous solution of 10 wt % lithium hydroxide was added. The resulting solution was stirred at 25° C. for 30 minutes, and then, water was distilled off under reduced pressure. The compound obtained was recrystallized from methanol to obtain the following compound F.

[Chem. 35]

C₈F₁₇CH₂CH₂—S—C₄H₈—SO₃Li F

### Synthesis Example 30 (Surfactant D: Containing Fluoroalkyl Group, Amine Oxide Group, and Hydroxyl Group)

In a 100 ml flask, 47.6 g (0.1 mol) of 1,2-epoxy-1H,1H,2H,3H,3H-heptadecafluoroundecane (manufactured by FUJIFILM Wako Chemical Co., Ltd.) and 20.4 g of (0.2 mol) dimethylaminopropylamine (manufactured by Tokyo Chemical Industry Co., Ltd.) were preliminarily well mixed, and the resulting mixture was heated to 60° C. to react, and aged for 16 hours. Subsequently, excessive amine was distilled off at 80° C. under vacuum to obtain 55.8 g of the following compound.

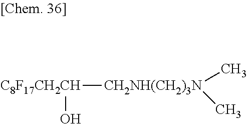

In a 100 ml flask, 9.79 g (0.0169 mol) of the above-mentioned compound, 35 g of ethanol, and 5 g of deionized water were preliminarily well mixed, and the resulting mixture was heated to 65° C. Thereto, 2.68 g (0.0237 mol) of a 30 wt % hydrogen peroxide solution was added dropwise, and aged at the same temperature for 4 hours to obtain the following compound G.

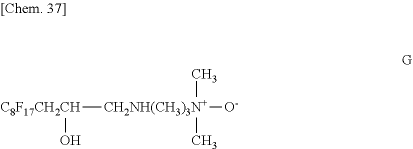

### Synthesis Example 31 (Surfactant H: Silicone Compound)

To a 1 L flask with a stirrer, reflux condenser, dropping funnel, thermometer, and nitrogen gas inlet, 100 g of cyclohexanone was added, and the resulting mixture was heated at 110° C. under a nitrogen gas atmosphere. With the cyclohexanone maintained at a temperature of 110° C., a liquid mixture of 90 g (0.91 mol) of an N,N-dimethylacrylamide (manufactured by Tokyo Chemical Industry Co., Ltd.), 10 g (0.01 mol) of SILAPLANE FM-0711 (manufactured by JNC Corporation), 1 g of tert-butylperoxy-2-ethylhexanoate, 2 g of dodecylmercaptan, and 200 g of cyclohexanone was added dropwise through a dropping funnel at a constant speed over a period of 2 hours to prepare a monomer solution. On completion of the dropwise addition, the monomer solution was heated to 115° C., and allowed to react for 2 hours, resulting in synthesizing a copolymer to obtain the following compound H.

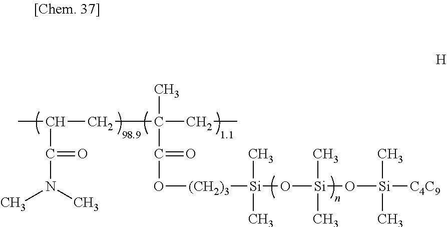

### Synthesis Example 32 (Surfactant I: Acrylic Compound)

To a 1 L flask with a stirrer, reflux condenser, dropping funnel, thermometer, and nitrogen gas inlet, 100 g of octanol was added, and the resulting mixture was heated at 100° C. under a nitrogen gas atmosphere. With the octanol maintained at a temperature of 100° C., a liquid mixture of 180 g (0.96 mol) of ethoxydiethylene glycol acrylate (manufactured by Tokyo Chemical Industry Co., Ltd.), 120 g (0.65 mol) of acryl acid-2-ethylhexyl (manufactured by Tokyo Chemical Industry Co., Ltd.), 1 g of tert-butylperoxy-2-ethylhexanoate, and 100 g of octanol was added dropwise through a dropping funnel at a constant speed over a period of 2 hours to synthesize a monomer solution. On completion of the dropwise addition, the monomer solution was heated to 115° C., and allowed to react for 2 hours to synthesize a copolymer. Then, the copolymer was diluted with octanol in such a manner that the remaining portion accounted for 50%, to obtain the following compound I.

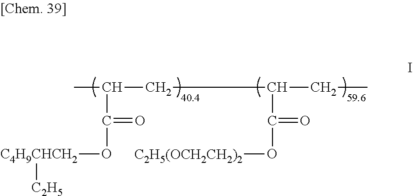

### Synthesis Example 33 (Surfactant J: Oxypropylene Compound)

In a 3 L flask equipped with a stirring blade, nitrogen gas inlet, thermocouple, condenser, and oil separating tube, 700 g of xylitol (manufactured by Tokyo Chemical Industry Co., Ltd.), 1291 g of 2,2-dimethoxypropane (manufactured by Tokyo Chemical Industry Co., Ltd.), and 27 mg of p-toluenesulfonic acid monohydrate were preliminarily well mixed, and the reaction system was held at 60 to 90° C., and allowed to react for 2 hours. On completion of the reaction, by-product methanol and excessive 2,2-dimethoxypropane were removed to obtain the following compound.

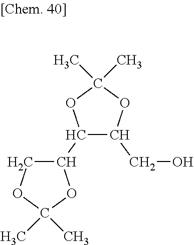 [SMILES: CC1(C)OCC(C2OC(C)(C)OC2CO)O1]

In an autoclave, 235 g of the above-described compound and 15.5 g of potassium hydroxide were preliminarily well mixed, the air in the autoclave was replaced with dry nitrogen. Then, with the mixture being stirred, the catalyst was completely dissolved at 140° C. Next, 2900 g of butylene oxide (manufactured by Tokyo Chemical Industry Co., Ltd.) was added dropwise using a dropping device, and the resulting mixture was stirred for 2 hours. Then, the reactant was taken out of the autoclave, neutralized with hydrochloric acid so as to have a pH of 6 to 7, subjected to a reduced pressure treatment at 100° C. for 1 hour to remove the water contained in the reactant, and finally filtered to remove salt. The following compound was thus obtained.

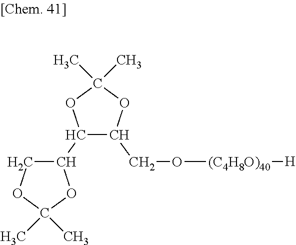

In a 1 L flask equipped with a stirring blade, nitrogen gas inlet, thermocouple, and condenser, 700 g of the above-described compound, 70 g of water, and 10 g of 36% hydrochloric acid were preliminarily well mixed. The resulting mixture underwent deketalization reaction at 80° C. in a sealed state for 2 hours, and then, water and acetone were distilled off from the system with nitrogen bubbling. Subsequently, the resulting product was adjusted to a pH of 6 to 7 with an aqueous 10% potassium hydroxide solution, and subjected to a reduced pressure treatment at 100° C. for 1 hour to remove the water contained. Furthermore, the resulting product was filtered to remove the salt generated after the treatment. The following compound J was thus obtained.

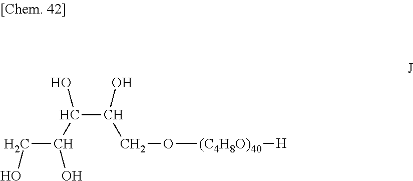

### Examples 1 to 40 and Comparative Examples 1 to 16

The evaluations were made in accordance with the following procedures.

### (1) Observation of Non-Woven Fabric during Production and Spinning

To 20 g of the polymer solution obtained in each Synthesis Example and having a resin concentration of 35 mass %, 0.47 g of a surfactant was added in such a manner that the composition was as described in Table 1 to 3. Furthermore, the resulting mixture was diluted with the same solvent as in the polymer solution to prepare a composition in such a manner that the concentration of the resin became 30 mass %. The compositions prepared are listed in Tables 1 to 3.

The resin solution was discharged at 40 μL/min using an electrospinning device (NEU Nanofiber Electrospinning Unit, manufactured by Kato Tech Co., Ltd.) to form a non-woven fabric having an areal weight of 5 g/m² on an aluminum foil. As the nozzle, an 18-gauge non-bevel needle (having an inner diameter of 0.94 mm) was used, and the distance to the collector was set at 15 cm. When the voltage was set, each sample at the tip of the nozzle was visually checked, and adjusted in such a manner that the resin solution was stably maintained in the shape of a cone (Taylor cone) at the tip of the nozzle. The non-woven fabric obtained on the aluminum foil was dried under vacuum at 150° C. to remove the residual solvent.

The fiber during electrospinning was visually checked for whitening, and the fiber without whitening was regarded as acceptable. The results are tabulated in Tables 1 to 3.

### (2) Observation of Non-Woven Fabric

The non-woven fabric obtained by an electrospinning method was observed under a scanning electron microscope (SEM). The accelerating voltage was set at 5 kV, and the magnification was set at 2000 times. Whether the non-woven fabric was deposited in fibrous form, not in droplet-like form, was verified by observation within the field of view, and the fabric deposited in fibrous form was regarded as acceptable. Furthermore, the number of beads was counted, and less than 50 was regarded as acceptable.

The composition adjusted in (1) was further left to stand at room temperature for 1 month. Then, a non-woven fabric was produced again by the method described in (1), and the number of beads was counted in the same manner. The results are tabulated in Tables 1 to 3.

### (3) Measurement of Fiber Diameter

By sputtering, gold was attached to the non-woven fabric obtained by an electrospinning method, and the resulting non-woven fabric was observed under a scanning electron microscope (SEM). The accelerating voltage was set at 5 kV, the magnification was set at 10,000 times, 30 fibers were randomly selected within the field of view, and the width of each fiber was measured. The arithmetic average of the measurements was calculated, and regarded as the fiber diameter. The results are tabulated in Tables 1 to 3.

### (4) Method of Measuring Tensile Strength of Non-Woven Fabric

The strength of the non-woven fabric was measured in Examples 3, 7, 13 to 15, 18, 21, 23, 25, 28, 32, and 35 and Comparative Examples 1, 3, 5, 7, 9, 11, 13, and 15. In this regard, the non-woven fabric in each of Examples 2 and 6 was composed of a precursor polymer solution, and hence, the following measurement was made after the non-woven fabric was heated to 280° C. at 5° C./minute at an oxygen concentration of 20 ppm or less using an inert oven (CLH-21CD-S; manufactured by Koyo Thermo Systems Co., Ltd.), heat-treated at 280° C. for 1 hour, and then cooled to 50° C. at 5° C./minute.

By the same method as in (1), the non-woven fabric that had undergone the removal of the residual solvent (and the subsequent heat treatment, in the case of Examples 3 and 7) was isolated from the aluminum foil, and measured for thickness using a micrometer. With the electrospinning time adjusted, a non-woven fabric having a thickness of 20 μm was produced.

Out of this non-woven fabric, a sample was cut in the form of a strip having a width of 1 cm and a length of approximately 5 cm, and used for strength measurement. For the tensile strength measurement, a “Tensilon” (RTM-100; manufactured by Orientec Co., Ltd.) was used, and the average of the values of the top five points in the measurement results was determined as the tensile strength. The results are tabulated in Tables 1 to 3.

### Tensile Strength Measurement Conditions

Temperature: 23° C.
Humidity: 45% RH
Full scale of load: 25 N
Crosshead speed: 50 mm/minute
Break detection sensitivity: 1.0%

### (5) Measurement of 5% Weight Loss Temperature of Resin

The polymer solution in each of Synthesis Examples 1 to 23 was applied to an 8-inch silicon wafer by spin coating, and then baked at 120° C. on a hot plate (coating and developing equipment Act-8; manufactured by Tokyo Electron Ltd.) for 3 minutes to obtain a resin film.

Using an inert oven (CLH-21CD-S; manufactured by Koyo Thermo Systems Co., Ltd.), this resin film was treated at an oxygen concentration of 20 ppm, as follows:
(A) in the case of Synthesis Examples 2, 4, 8, 10 to 13, and 17,
the resin film was heated to 280° C. at 5° C./minute, and heat-treated at 280° C. for 1 hour;
(B) in the case of Synthesis Examples 3, 5, 6, 7, 9, 14 to 16, and 18 to 23,
the resin film was heated to 150° C. at 5° C./minute, and heat-treated at 150° C. for 1 hour; and then, the resin film was cooled to 50° C. at 5° C./minute. Subsequently, the resin film was immersed in hydrofluoric acid for 1 to 4 minutes, and the film was thus peeled off from the substrate, and air-dried to obtain a heat-treated coating film. The rotational speed for the spin coating was adjusted in such a manner that the thickness of the resin film heat-treated became 10 μm. When this was done, the thickness of the film was measured using an optical interference type film thickness measuring device (Lambda Ace STM-602; manufactured by SCREEN Holdings Co., Ltd.).

This coating film was set in a thermogravimetric device (TGA-50; manufactured by Shimadzu Corporation), and the resin was heated to 150° C. at a heating rate of 10° C./minute to remove adsorbed water. Then, the resin was once cooled to room temperature, and the weight W1 of the resin was measured. This resin was again heated at a heating rate of 10° C./minute, and a temperature at which the weight W2 of the resin during this heating satisfied W2/W1=0.95 was regarded as the 5% weight loss temperature. The results are tabulated in Table 4.

TABLE 1

| | | | | | | | After Being Stored | | |
|---|---|---|---|---|---|---|---|---|---|
| | | | | | | | at Room Temperature | | |
| | | | | | Not Stored at | | for 1 month | | |
| | | | | | Room Temperature | | | Number | |
| | | | | | Number | Fiber | Number | of Beads | Tensile |
| | Polymer | | Whitening | Form of Deposition | of Beads | Diameter | of Beads | Increased | Strength |
| | Solution | Surfactant | of Fiber | of Product Discharged | (beads) | (μm) | (beads) | (beads) | (N/cm) |
| Example 1 | PES-01 | A | No | Deposited in Fibrous Form | 45 | 3.9 | >50 | — | 1 |
| Example 2 | PAA-01 | D | No | Deposited in Fibrous Form | 8 | 1.6 | >50 | — | — |
| Example 3 | PAA-02 | A | No | Deposited in Fibrous Form | 35 | 3.5 | >50 | — | 1.1 |
| Example 4 | PAA-02 | B | No | Deposited in Fibrous Form | 16 | 2.2 | >50 | — | — |
| Example 5 | PAA-02 | C | No | Deposited in Fibrous Form | 7 | 0.9 | >50 | — | — |
| Example 6 | PAA-02 | D | No | Deposited in Fibrous Form | 8 | 0.8 | >50 | — | — |
| Example 7 | PAA-02 | E | No | Deposited in Fibrous Form | 27 | 0.8 | >50 | — | 1.6 |
| Example 8 | PAA-02 | F | No | Deposited in Fibrous Form | 25 | 1.2 | >50 | — | — |
| Example 9 | PAA-02 | G | No | Deposited in Fibrous Form | 8 | 0.9 | >50 | — | — |
| Example 10 | PAA-03 | C | No | Deposited in Fibrous Form | 8 | 0.5 | >50 | — | — |
| Example 11 | PI-01 | D | No | Deposited in Fibrous Form | 9 | 1.6 | 35 | 26 | — |
| Example 12 | PI-02 | C | No | Deposited in Fibrous Form | 7 | 0.5 | 32 | 25 | — |
| Example 13 | PI-03 | B | No | Deposited in Fibrous Form | 15 | 2.2 | 43 | 28 | 2.1 |
| Example 14 | PI-03 | C | No | Deposited in Fibrous Form | 8 | 0.4 | 32 | 24 | 2.7 |
| Example 15 | PI-03 | D | No | Deposited in Fibrous Form | 7 | 0.5 | 33 | 26 | 2.7 |
| Example 16 | PI-03 | E | No | Deposited in Fibrous Form | 25 | 0.6 | 48 | 23 | — |
| Example 17 | PI-03 | G | No | Deposited in Fibrous Form | 9 | 0.8 | 33 | 24 | — |
| Example 18 | PI-04 | D | No | Deposited in Fibrous Form | 8 | 0.9 | 32 | 24 | 2.7 |
| Example 19 | PAIA-01 | D | No | Deposited in Fibrous Form | 8 | 1.6 | 33 | 25 | — |
| Example 20 | PAIA-02 | C | No | Deposited in Fibrous Form | 8 | 0.5 | 32 | 24 | — |
| Example 21 | PAI-01 | D | No | Deposited in Fibrous Form | 9 | 0.9 | 10 | 1 | 2.6 |
| Example 22 | PAI-02 | C | No | Deposited in Fibrous Form | 9 | 0.5 | 10 | 1 | — |
| Example 23 | PAI-02 | B | No | Deposited in Fibrous Form | 16 | 2.4 | 20 | 4 | 2.2 |
| Example 24 | PAI-02 | E | No | Deposited in Fibrous Form | 26 | 0.7 | 26 | 0 | — |
| Example 25 | PAI-02 | G | No | Deposited in Fibrous Form | 9 | 0.8 | 10 | 1 | 2.7 |
| Example 26 | PAI-03 | D | No | Deposited in Fibrous Form | 9 | 1.6 | 10 | 1 | — |

TABLE 2

| | | | | | | | After Being Stored | | |
|---|---|---|---|---|---|---|---|---|---|
| | | | | | | | at Room Temperature | | |
| | | | | | Not Stored at | | for 1 month | | |
| | | | | | Room Temperature | | | Number | |
| | | | | | Number | Fiber | Number | of Beads | Tensile |
| | Polymer | | Whitening | Form of Deposition | of Beads | Diameter | of Beads | Increased | Strength |
| | Solution | Surfactant | of Fiber | of Product Discharged | (beads) | (μm) | (beads) | (beads) | (N/cm) |
| Example 27 | PA-01 | D | No | Deposited in Fibrous Form | 7 | 1.6 | 32 | 25 | — |
| Example 28 | PA-02 | D | No | Deposited in Fibrous Form | 7 | 0.9 | 33 | 26 | 2.7 |
| Example 29 | PA-03 | C | No | Deposited in Fibrous Form | 7 | 0.5 | 31 | 24 | — |
| Example 30 | PU-01 | D | No | Deposited in Fibrous Form | 7 | 1.7 | 31 | 24 | — |
| Example 31 | PU-02 | D | No | Deposited in Fibrous Form | 8 | 0.9 | 33 | 25 | — |
| Example 32 | PU-03 | B | No | Deposited in Fibrous Form | 17 | 2.3 | 43 | 26 | 2.1 |
| Example 33 | PU-03 | C | No | Deposited in Fibrous Form | 7 | 0.5 | 33 | 26 | — |
| Example 34 | PU-03 | D | No | Deposited in Fibrous Form | 7 | 0.5 | 33 | 26 | — |
| Example 35 | PU-03 | E | No | Deposited in Fibrous Form | 26 | 0.6 | 49 | 23 | 1.6 |
| Example 36 | PU-03 | G | No | Deposited in Fibrous Form | 8 | 0.5 | 32 | 24 | — |
| Example 37 | PBOA-01 | D | No | Deposited in Fibrous Form | 8 | 1.6 | 32 | 24 | — |
| Example 38 | PBO-01 | D | No | Deposited in Fibrous Form | 9 | 1.6 | 33 | 24 | — |
| Example 39 | PBTA-01 | D | No | Deposited in Fibrous Form | 8 | 1.6 | 31 | 23 | — |
| Example 40 | PBIA-01 | D | No | Deposited in Fibrous Form | 8 | 1.6 | 31 | 23 | — |

TABLE 3

| | | | | | Number | Fiber | Tensile |
|---|---|---|---|---|---|---|---|
| | Polymer | | Whitening | Form of Deposition | of Beads | Diameter | Strength |
| | Solution | Surfactant | of Fiber | of Product Discharged | (beads) | (μm) | (N/cm) |
| Comparative | PAA-02 | None | No | Deposited in Fibrous Form | >50 | 6.3 | 0.2 |
| Example 1 | | | | | | | |
| Comparative | PAA-02 | H | Yes | Deposited in Round Droplet- | Unmeasurable | Unmeasurable | Unmeasurable |
| Example 2 | | | | like Form | | | |
| Comparative | PAA-02 | I | No | Deposited in Fibrous Form | >50 | 8.8 | 0.3 |
| Example 3 | | | | | | | |
| Comparative | PAA-02 | J | No | Deposited in Round Droplet- | Unmeasurable | Unmeasurable | Unmeasurable |
| Example 4 | | | | like Form | | | |
| Comparative | PI-03 | None | No | Deposited in Fibrous Form | >50 | 5.2 | 0.4 |
| Example 5 | | | | | | | |
| Comparative | PI-03 | H | Yes | Deposited in Round Droplet- | Unmeasurable | Unmeasurable | Unmeasurable |
| Example 6 | | | | like Form | | | |
| Comparative | PI-03 | I | No | Deposited in Fibrous Form | >50 | 8 | 0.5 |
| Example 7 | | | | | | | |
| Comparative | PI-03 | J | No | Deposited in Round Droplet- | Unmeasurable | Unmeasurable | Unmeasurable |
| Example 8 | | | | like Form | | | |
| Comparative | PAI-02 | None | No | Deposited in Fibrous Form | >50 | 4.8 | 0.4 |
| Example 9 | | | | | | | |
| Comparative | PAI-02 | H | Yes | Deposited in Round Droplet- | Unmeasurable | Unmeasurable | Unmeasurable |
| Example 10 | | | | like Form | | | |
| Comparative | PAI-02 | I | No | Deposited in Fibrous Form | >50 | 8.5 | 0.5 |
| Example 11 | | | | | | | |
| Comparative | PAI-02 | J | No | Deposited in Round Droplet- | Unmeasurable | Unmeasurable | Unmeasurable |
| Example 12 | | | | like Form | | | |
| Comparative | PU-03 | None | No | Deposited in Fibrous Form | >50 | 4.3 | 0.4 |
| Example 13 | | | | | | | |
| Comparative | PU-03 | H | Yes | Deposited in Round Droplet- | Unmeasurable | Unmeasurable | Unmeasurable |
| Example 14 | | | | like Form | | | |
| Comparative | PU-03 | I | No | Deposited in Fibrous Form | >50 | 8.2 | 0.5 |
| Example 15 | | | | | | | |
| Comparative | PU-03 | J | No | Deposited in Round Droplet- | Unmeasurable | Unmeasurable | Unmeasurable |
| Example 16 | | | | like Form | | | |

TABLE 4

| | Polymer | 5% Weight Loss Temperature |
|---|---|---|
| Synthesis Example | Solution | (° C.) |
| Synthesis Example 1 | PES-01 | 402 |
| Synthesis Example 2 | PAA-01 | 557 |
| Synthesis Example 12 | PAA-02 | 530 |
| Synthesis Example 13 | PAA-03 | 510 |
| Synthesis Example 3 | PI-01 | 480 |
| Synthesis Example 14 | PI-02 | 488 |
| Synthesis Example 15 | PI-03 | 478 |
| Synthesis Example 16 | PI-04 | 480 |
| Synthesis Example 4 | PAIA-01 | 432 |
| Synthesis Example 17 | PAIA-02 | 430 |
| Synthesis Example 5 | PAI-01 | 423 |
| Synthesis Example 18 | PAI-02 | 453 |
| Synthesis Example 19 | PAI-03 | 420 |
| Synthesis Example 6 | PA-01 | 350 |
| Synthesis Example 20 | PA-02 | 360 |
| Synthesis Example 21 | PA-03 | 365 |
| Synthesis Example 7 | PU-01 | 320 |
| Synthesis Example 22 | PU-02 | 334 |
| Synthesis Example 23 | PU-03 | 342 |
| Synthesis Example 8 | PBOA-01 | 480 |
| Synthesis Example 9 | PBO-01 | 453 |
| Synthesis Example 10 | PBTA-01 | 543 |
| Synthesis Example 11 | PBIA-01 | 565 |

1. A resin composition for forming a non-woven fabric by an electrospinning method, comprising: (a) at least one heat-resistant resin or a precursor thereof, said heat-resistant resin being selected from the group consisting of a heat-resistant resin containing a nitrogen atom and a heat-resistant resin containing, in the main chain, a group selected from the group consisting of ether group, ketone group, sulfone group, and sulfide group; (b) a solvent; and (c) a surfactant having a fluoroalkyl group.

2. The resin composition according to claim 1, wherein (c) said surfactant having a fluoroalkyl group has at least one group selected from an oxyethylene group, oxypropylene group, or group containing quaternary nitrogen.

3. The resin composition according to claim 1, wherein (c) said surfactant having a fluoroalkyl group is a compound having a group selected from the group consisting of a carboxyl group, sulfonic acid group, and hydroxyl group, or is an alkali metal salt or alkaline earth metal salt of said compound.

4. The resin composition according to any one of claims 1 to 3, wherein (c) said surfactant having a fluoroalkyl group does not have a structure in which repeating units containing a fluoroalkyl group are linked.

5. The resin composition according to any one of claims 1 to 4, wherein said heat-resistant resin of the component (a) is a resin selected from the group consisting of a polyimide, polyamide imide, polyamide, polybenzoxazole, polybenzothiazole, polybenzimidazole, polyurea, polyether ketone, polyether ether ketone, polyether sulfone, and polyphenylene sulfide.

6. The resin composition according to any one of claims 1 to 5, wherein said heat-resistant resin of the component (a) has a structure represented by at least one selected from the following general formulae (1) to (5): 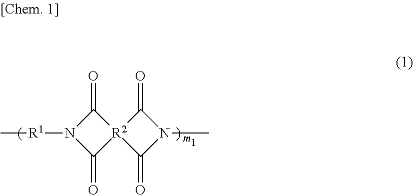
(wherein, in the general formula (1), R¹ represents a C₂₋₅₀ divalent group; R² represents a C₄₋₅₀ tetravalent group; and m₁ represents an integer of 1 to 10,000); 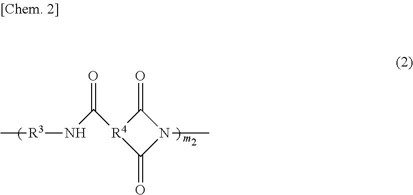
(wherein, in the general formula (2), R³ represents a C₂₋₅₀ divalent group; R⁴ represents a C₄₋₅₀ trivalent group; and m₂ represents an integer of 1 to 10,000); 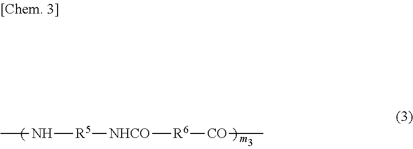
(wherein, in the general formula (3), R⁵ represents a C₂₋₅₀ divalent group; R⁶ represents a C₂₋₅₀ divalent group; and m₃ represents an integer of 1 to 10,000); 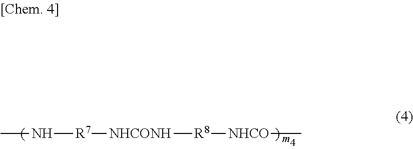
(wherein, in the general formula (4), R⁷ represents a C₂₋₅₀ divalent group; R⁸ represents a C₂₋₅₀ divalent group; and m₄ represents an integer of 1 to 10,000); or 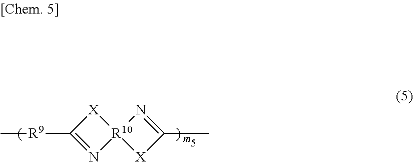
(wherein, in the general formula (5), R⁹ represents a C₂₋₅₀ divalent group; R¹⁰ represents a C₄₋₅₀ tetravalent group; X represents a divalent group selected from —O—, —S—, —NH—, and —C(═O)O—; and m₅ represents an integer of 1 to 10,000).

7. The resin composition according to claim 6, wherein 30 mol % or more of each of R¹ in the general formula (1), R³ in the general formula (2), R⁵ in the general formula (3), R⁶ in the general formula (3), R⁷ in the general formula (4), R⁸ in the general formula (4), and R⁹ in the general formula (5) has a structure represented by the following general formula (6) or the general formula (7): 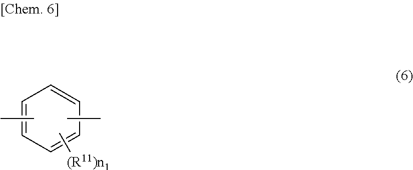
(wherein, in the general formula (6), R¹¹ represents a C₁₋₆ monovalent group, and is at an ortho position with respect to the main chain of the polymer; and n₁ represents an integer of 1 to 4); 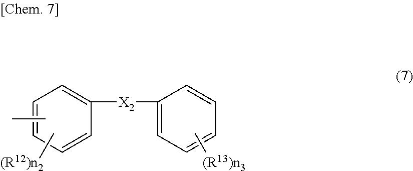
(wherein, in the general formula (7), R¹² and R¹³ each independently represent a C₁₋₆ monovalent group, and is at an ortho position with respect to the main chain of the polymer; n₂ and n₃ each independently represent an integer of 1 to 4; and X₂ represents at least one selected from a single bond, —O—, —S—, —CH₂—, —C(CH₃)₂—, or —C(CF₃)₂—).

8. A non-woven fabric comprising: (a) at least one heat-resistant resin or a precursor thereof, said heat-resistant resin being selected from the group consisting of a heat-resistant resin containing a nitrogen atom and a heat-resistant resin containing, in the main chain, a group selected from the group consisting of ether group, ketone group, sulfone group, and sulfide group; and (c) a surfactant having a fluoroalkyl group.

9. The non-woven fabric according to claim 8, wherein (c) said surfactant having a fluoroalkyl group has at least one group selected from the group consisting of oxyethylene group, oxypropylene group, and group containing quaternary nitrogen.

10. The non-woven fabric according to claim 8, wherein (c) said surfactant having a fluoroalkyl group is a compound having a group selected from the group consisting of a carboxyl group, sulfonic acid group, and hydroxyl group, or is an alkali metal salt or alkaline earth metal salt of said compound.

11. The non-woven fabric according to any one of claims 8 to 10, wherein (c) said surfactant having a fluoroalkyl group does not have a structure in which repeating units containing a fluoroalkyl group are linked.

12. The non-woven fabric according to any one of claims 8 to 11, wherein said heat-resistant resin of the component (a) is a resin selected from the group consisting of a polyimide, polyamide imide, polyamide, polybenzoxazole, polybenzothiazole, polybenzimidazole, polyurea, polyether ketone, polyether ether ketone, polyether sulfone, and polyphenylene sulfide.

13. The non-woven fabric according to any one of claims 8 to 12, wherein said heat-resistant resin of the component (a) has a structure represented by at least one selected from the following general formulae (1) to (5): 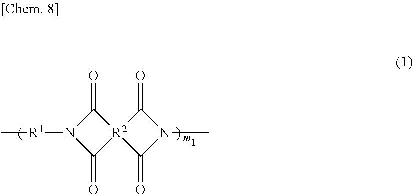
(wherein, in the general formula (1), R¹ represents a C₂₋₅₀ divalent group; R² represents a C₄₋₅₀ tetravalent group; and m₁ represents an integer of 1 to 10,000); 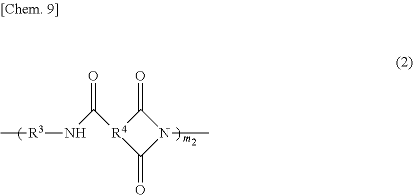
(wherein, in the general formula (2), R³ represents a C₂₋₅₀ divalent group; R⁴ represents a C₄₋₅₀ trivalent group; and m₂ represents an integer of 1 to 10,000); 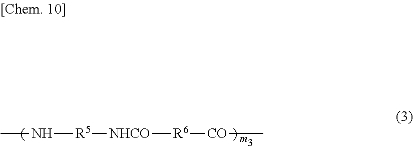
(wherein, in the general formula (3), R⁵ represents a C₂₋₅₀ divalent group; R⁶ represents a C₂₋₅₀ divalent group; and m₃ represents an integer of 1 to 10,000); 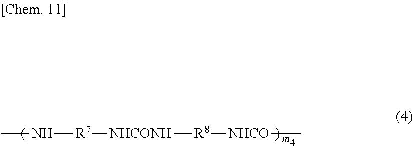
(wherein, in the general formula (4), R⁷ represents a C₂₋₅₀ divalent group; R⁸ represents a C₂₋₅₀ divalent group; and m₄ represents an integer of 1 to 10,000); or 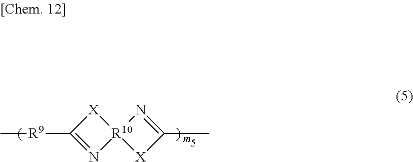
(wherein, in the general formula (5), R⁹ represents a C₂₋₅₀ divalent group; R¹⁰ represents a C₄₋₅₀ tetravalent group; and X represents a divalent group selected from —O—, —S—, —NH—, and —C(═O)O—; and m₅ represents an integer of 1 to 10,000).

14. The resin composition according to claim 13, wherein 30 mol % or more of each of R¹ in the general formula (1), R³ in the general formula (2), R⁵ in the general formula (3), R⁶ in the general formula (3), R⁷ in the general formula (4), R⁸ in the general formula (4), and R⁹ in the general formula (5) has a structure represented by the following general formula (6) or the general formula (7): 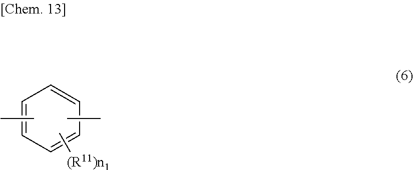
(wherein, in the general formula (6), R¹¹ represents a C₁₋₆ monovalent group, and is at an ortho position with respect to the main chain of the polymer; and n₁ represents an integer of 1 to 4); or 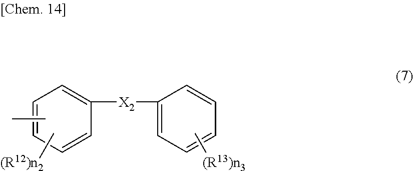
(wherein, in the general formula (7), R¹² and R¹³ each independently represent a C₁₋₆ monovalent group, and is at an ortho position with respect to the main chain of the polymer; n₂ and n₃ each independently represent an integer of 1 to 4; and X₂ represents at least one selected from a single bond, —O—, —S—, —CH₂—, —C(CH₃)₂—, or —C(CF₃)₂—).

15. A method of producing a non-woven fabric, comprising forming a non-woven fabric by electrospinning using said resin composition according to any one of claims 1 to 7.

16. A fiber product comprising said non-woven fabric according to any one of claims 8 to 14.

17. A separator for an electricity storage element, comprising said non-woven fabric according to any one of claims 8 to 14.

18. A secondary battery comprising the separator according to claim 17.

19. An electric double layer capacitor comprising the separator according to claim 17.
